(19) United States
(12) Patent Application Publication
(10) Pub. No.: US 2026/0280110 A1
(43) Pub. Date: Sep. 17, 2026

(54) RADAR TRANSMISSIVE SYSTEMS, METHODS OF MANUFACTURE THEREOF, ASSEMBLIES THEREOF, AND METHODS OF USE THEREOF

(71) Applicant: PPG INDUSTRIES OHIO, INC., Cleveland, OH (US)

(72) Inventors: Eldon Lorenzo Decker, Gibsonia, PA (US); Scott Joseph Moravek, Mars, PA (US); Nicolas Benjamin Duarte, Allison Park, PA (US); Daniel Martin Connor, Evans City, PA (US); Hao Sun, Pittsburgh, PA (US); Michelle Passmann, Stuttgart (DE); Yurun Yang, Shanghai (CN); Li Luan, Chicago, IL (US); Yihua Wang, Shanghai (CN); Kora Förster, Stuttgart (DE); David Leonardo Gonzalez Arellano, Allison Park, PA (US)

(73) Assignee: PPG INDUSTRIES OHIO, INC., Cleveland, OH (US)

(21) Appl. No.: 18/871,944

(22) PCT Filed: Jun. 5, 2023
(86) PCT No.: PCT/US2023/067909

§ 371 Date: Dec. 5, 2024

Related U.S. Application Data
(60) Provisional application No. 63/365,915, filed on Jun. 6, 2022.

(51) Int. Cl. H01Q 1/42; H01Q 1/32

(52) U.S. Cl. CPC H01Q 1/42; H01Q 1/3233

(57) ABSTRACT

Radar transmissive systems, methods of manufacture thereof, assemblies thereof, and methods of use thereof are provided. The radar transmissive system comprises a substrate, a first layer, and a second layer. The substrate comprises a first surface and a second surface positioned opposite the first surface. The second surface is configured to be directed towards a radar system. The first layer is applied over at least a portion of the first surface of the substrate. The second layer is applied over at least a portion of the second surface of the substrate. A dry film thickness of the second layer is configured to reduce radar transmission loss through the radar transmissive system based on a permittivity and a thickness of the first layer and the substrate layer in the radar transmissive system. The radar transmissive system transmits 50% or greater of electromagnetic radiation.

### FIELD

The present disclosure relates to radar transmissive systems, methods of manufacture thereof, assemblies, and methods of use thereof.

### BACKGROUND

The use of radar is becoming ubiquitous in modern transportation including passenger vehicles with advanced driver assistance systems (ADAS), such as adaptive cruise control (ACC), automatic braking, and the like. The use of radar will likely increase as additional advances in autonomous driving are implemented. However, radar performance can be hindered by unwanted radar signal loss caused by a bumper or mirror housing that the radar may be positioned behind. Accordingly, systems and assemblies that minimize interference with radar while providing the desired appearance are desired.

### SUMMARY

The present disclosure relates to a radar transmissive system comprising a substrate layer, a first layer, and a second layer. The substrate layer comprises a first surface and a second surface positioned opposite the first surface. The second surface is configured to be directed towards a radar system. The first layer is applied over at least a portion of the first surface of the substrate layer. The second layer is applied over at least a portion of the second surface of the substrate layer. A dry film thickness of the second layer is configured to reduce radar transmission loss through the radar transmissive system based on the relative electric permittivity, herein referred to as “permittivity” and a thickness of the substrate layer and the first layer. The radar transmissive system transmits 50% or greater of electromagnetic radiation comprising a frequency of 1 GHz to 300 GHz, such as, 1 GHz to 100 GHz or 76 GHz to 81 GHz, through the radar transmissive system, such as, 60% or greater, 70% or greater, 75% or greater, 80% or greater, 85% or greater, or 90% or greater of electromagnetic radiation comprising a frequency in a range of 1 GHz to 300 GHz, such as, 1 GHz to 100 GHz or 76 GHz to 81 GHZ, through the radar transmissive system.

The present disclosure also relates to a method of making a radar transmissive system. The method comprises depositing a first layer over a first surface of a substrate layer. A desired dry film thickness of a second layer is selected based on the permittivity and thickness of the substrate layer and the first layer such that radar transmission loss through the radar transmissive system is reduced. The second layer is deposited at the selected desired film thickness over a second surface of the substrate layer. The second surface is positioned opposite the first surface. The second surface is configured to be directed towards a radar system. The second layer is deposited to reduce radar transmission loss through the radar transmissive system.

It is understood that this disclosure is not limited to the examples summarized in this Summary. Various other aspects are described and exemplified herein.

### BRIEF DESCRIPTION OF THE DRAWINGS

The features and advantages of the examples, and the manner of attaining them, will become more apparent, and the examples will be better understood, by reference to the following description taken in conjunction with the accompanying drawings, wherein:

FIG. 1 is a schematic view of a radar transmissive system according to the present disclosure;

FIG. 2 is a plot of one-way radar transmission loss (OWRTL) relative to permittivity of Examples 1-6 using methods A-E, in accordance with the present disclosure;

FIG. 3 is a plot of one-way radar transmission loss relative to permittivity of Examples 7-12 using methods A-E in accordance with the present disclosure;

FIG. 4 is a plot of one-way radar transmission loss relative to permittivity of Examples 13-18 using methods A-E in accordance with the present disclosure;

FIG. 5 is a plot of one-way radar transmission loss relative to permittivity of Examples 19-24 using methods A-E in accordance with the present disclosure;

FIG. 6 is a plot of one-way radar transmission loss relative to permittivity of Examples 37-42 using methods A-E in accordance with the present disclosure;

FIG. 7 is a plot of one-way radar transmission loss relative to permittivity of Examples 55-72 using methods A-E in accordance with the present disclosure; and

FIG. 8 is a plot of one-way radar transmission loss relative to permittivity based on thickness of an uncoated substrate layer in accordance with the present disclosure.

The exemplifications set out herein illustrate certain non-limiting embodiments, in one form, and such exemplifications are not to be construed as limiting the scope of the appended claims in any manner.

### DETAILED DESCRIPTION

In many applications, a radar system is positioned behind a cover, such as a radome, a bumper, or a mirror housing to ensure desired aesthetics and/or protection for the radar system. However, radar performance can be hindered by unwanted radar signal loss, transmitted and received, caused by the cover, including any coating layers of the cover. For example, the change in permittivity through the thickness of the cover and the total thickness of the cover can affect the amount of radar signal loss observed. To offset the unwanted radar signal loss, a more powerful radar system may have to be employed, that may result in increased costs and/or size of the radar system.

The present disclosure provides radar transmissive systems and assemblies thereof that can achieve desirable aesthetics and/or minimal, if any, radar transmission loss through the radar transmissive systems and assemblies thereof.

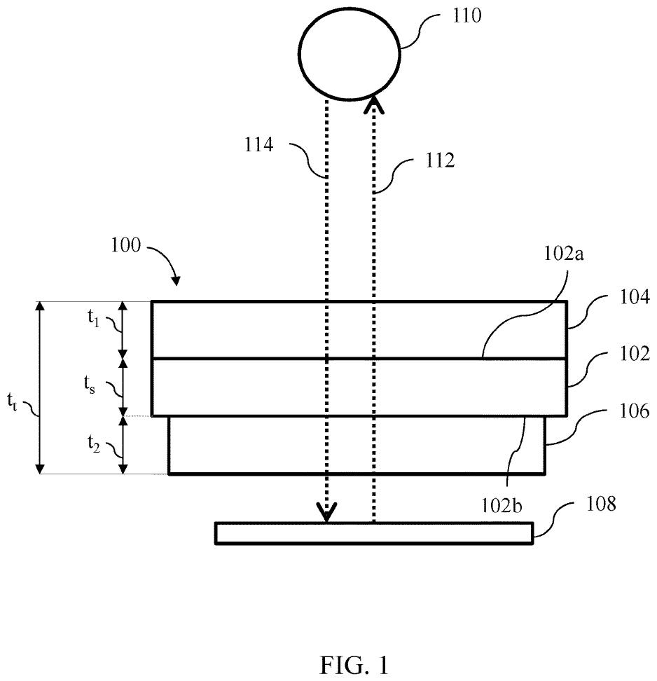

FIG. 1 is a schematic view of a radar transmissive system 100 of the present disclosure comprising a substrate layer 102, a first layer 104, and a second layer 106. The substrate layer 102 comprises a first surface 102a and a second surface 102b positioned opposite the first surface 102a. The first surface 102a and the second surface 102b can be parallel or may not be parallel. The first layer 104 is applied over at least a portion of the first surface 102a of the substrate layer 102 and the second layer 106 is applied over at least a portion of the second surface 102b of the substrate layer 102. In use, the second surface 102b can be directed towards a radar system 108.

As used herein, the terms “on,” “applied over,” “applied on,” “formed over,” “formed on, “deposited over,” “deposited on,” “overlay,” “provided over,” “provided on,” and the like, mean formed, overlaid, deposited, or provided on but not necessarily in contact with the surface. For example, a formed layer “applied over” a substrate layer does not preclude the presence of one or more other layers of the same or different composition located between the formed layer and the substrate layer.

The first layer 104 can be a coating, a film, or a combination thereof. The second layer 106 can be a coating, a film, or a combination thereof. For example, the second layer 106 can be a coating and can be in direct contact with the substrate layer 102. As used herein, a “coating” is a surface covering, such as, for example, a paint for at least a portion of an object that can be applied in, for instance, liquid, paste, slurry, or powder form, which upon drying and/or curing, forms a self-supporting continuous film over a least a portion of the object. A film is a surface covering for at least a portion of an object that is applied as a solid and pliable layer, which is solidified (e.g., thermoplastics), cured (e.g., thermosets) and/or dried prior to application to at least a portion of the object.

In some instances, the second layer 106 may be referred to as a backer layer. The second layer 106 can comprise a film-forming resin and optionally a filler, such as, for example, talc, calcium carbonate, clays, silica, sulfate or sulfite minerals (e.g. barium sulfate), metal oxides (e.g., titanium dioxide, iron oxide, micaceous iron oxide, aluminum oxide, zinc oxide), titanate compounds (e.g., barium titanate, calcium copper titanate, sodium titanate, strontium titanate), sulfide minerals (e.g. iron sulfide), metal flakes or powders (e.g. aluminum flakes), other ceramic powders (e.g. boride, carbide, or nitride compounds), carbon (e.g., radar transmissive carbons), silicon, germanium, hydrogenated amorphous-silicon, glass flakes or spheres, other pigments, a fibrous material, or a combination thereof. Use of any of the listed filler materials, or a combination thereof, can generally increase the permittivity of the second layer 106. The second layer 106 may further optionally comprise gas pockets or a hollow pigment. Using gas pockets or a hollow pigment, or a combination thereof, can generally lower the permittivity of the second layer 106.

The filler may be incorporated into the second layer 106 at an appropriate concentration to control the permittivity of the second layer 106 and allow for increased radar transmission through the radar transmissive section. For instance, the second layer 106 may comprise a film-forming layer with a pigment volume concentration (PVC) of 0% to 90% of the filler in the solid layer, such as 1% to 50%, such as 5% to 30%, such as 10% to 20%. The second layer 106 may be hidden from view by an operator or other person when the radar transmissive system 100 is in use.

The first layer 104 can comprise a film-forming resin and a pigment. For example, the first layer 104 can be applied over at least a portion of the substrate layer 102 for aesthetics of the substrate layer 102 while the second layer 106 can be applied over at least a portion of the substrate layer 102 for reduction in radar transmission loss of the radar transmissive system 100. The first layer 104, when applied over at least a portion of the substrate layer 102, can comprise a desirable metallic luster as indicated by a L₁₅ value. The reflectance of a coating, film, and/or article can be quantified using the International Commission on Illumination (CIE) L₁₅ value as discussed here. CIE L*a*b* (or CIE L*C*h) color values can be measured using a multi-angle spectrophotometer, such as a BYKMAC I, from ALTANA, at the measurement angles of 15°, 25°, 45°, 75°, and/or 110° relative to the specular direction, with D65 illumination and 10° observer. The L* lightness values at the measurement angle of 15° will be referred to as L₁₅. The first layer 104 can comprise an L₁₅ value of 115 or greater as measured using a multi-angle spectrophotometer on the substrate layer 102, such as, for example, 120 or greater, 125 or greater, 130 or greater, 140 or greater, 150 or greater, or 160 or greater, all as measured using a multi-angle spectrophotometer on the substrate layer 102. The first layer 104 may comprise an L₁₅ value of less than 115 and may have limited if any metallic luster. The first layer 104 may comprise a color comprising a hue value of h=0° to 359° and a chroma value C*≥50 or C*≤50 as measured at a measurement angle from 15° to 110° using a multi-angle spectrophotometer.

For purposes of this description and claims, the following devices may be used in connection with various measurements disclosed herein. For example, any number of suitable spectrophotometers can be used in accordance with the present disclosure, including but not limited to a BYKMAC I device, made by ALTANA. A suitable measurement system for use in measuring film/coating thicknesses can comprise any number of different available devices in the industry, including but not limited to the FISCHERSCOPE MMS PC2, from FISCHER TECHNOLOGY, INC.

One-way radar transmission loss can be measured using an “R&S device,” or other suitable devices with similar or identical functionality as that noted herein. In one example, an R&S device refers to use of a frequency generator (such as an SMA 100B with SMAB92/SMAB-B120, from ROHDE & SCHWARZ USA, INC.) connected to a 6-times multiplier (such as an SMZ90, from ROHDE & SCHWARZ USA, INC.) via a 3.5 mm male to 3.5 mm male coaxial cable (such as FM160FLEX, from FAIRVIEW MICROWAVE), a thermal waveguide power sensor (such as NRP90TWG, from ROHDE & SCHWARZ USA, INC.), and a USB power cable between the signal generator and the thermal waveguide power sensor (such as NRP-ZKU, from ROHDE & SCHWARZ USA, INC.), with two E-band spot focusing lens antennas (such as 1.7″ focal length SAQ-813017-12-S1, from SAGE MILLIMETER). In this R&S setup, one lens is attached to the 6 times multiplier, and the other to the thermal waveguide power sensor, with the two lenses in line, facing each other. In addition, two measurements of the transmitted power are taken, first with no sample (or material-under-test) between the lenses, and second with a sample between the lenses, in the center region between the two lenses (at the focal point between them). The power readings for these two measurements can be used to calculate the one-way radar transmission loss, or OWRTL for the sample as such: OWRTL=10 log₁₀(P₀/Pₘᵤₜ), where P₀ is the transmitted power with no sample between the lenses, and Pₘᵤₜ is the power transmitted with a sample between the lenses.

In addition to the foregoing, permittivity can be measured with any number or arrangement of suitable devices, including but not limited to the “Radome Measurement System” (or RMS-D) from PERISENS, GMBH at a frequency in range of 76 GHz to 81 GHz.

The second layer 106 can comprise a haze of no greater than 50% as measured according to ASTM D1003 or the second layer 106 can comprise a haze of at least 50% as measured according to ASTM D1003 based on the desired application.

The first layer 104 and the second layer 106, individually, can be an automotive original equipment manufacturer coating, an automotive refinish coating, an industrial coating, an architectural coating, a coil coating, a packaging coating, a marine coating, an aerospace coating, a consumer electronic coating, the like, or combinations thereof.

As used herein, “pigment” refers to an insoluble particle that provides reflective characteristics in the visible wavelengths of the electromagnetic spectrum. As used herein, the term “visible” refers to the visible wavelengths of the electromagnetic spectrum. For example, the visible wavelengths may be in a range of 400 nm to 700 nm. The pigments according to the present disclosure can provide visible light reflective characteristics to a composition that incorporates the pigment. In some cases, the pigment may be considered as a filler for calculation of the total pigment volume concentration.

As used herein, “insoluble” in reference to a pigment means the pigment (including the components that comprise the pigment) is insoluble in water and the typical solvents, such as organic solvents, used in coating compositions, film compositions, and article of manufacture compositions. Solubility may be tested, for example, by making a 1 weight percent (wt %) mixture of the solute (e.g., pigment particle) in the desired medium based on the total weight of mixture, such as water and/or organic solvent(s), at ambient temperature. If the pigment dissolves into the desired medium, it is soluble. If the pigment remains as a separate phase, it is insoluble. Thus, when formulating a coating, a film, or an article incorporating the pigment, solvent(s) in which the pigment is insoluble may be chosen.

As used herein, “ambient temperature” refers to a temperature of from 10° C. to 30° C., such as from 20° C. to 26° C.

The substrate layer 102 can comprise a radar transmissive substrate. A “radar transmissive substrate” means a substrate having a composition and a thickness suitable to transmit electromagnetic radiation at various radar frequencies (e.g., in the range of automotive radar frequencies of 76 GHz to 81 GHz) with minimal, if any, transmission loss. “Minimal” with respect to transmission loss is meant to mean no greater than 5 dB, such as, for example, no greater than 4 dB, no greater than 3 dB, no greater than 2 dB, no greater than 1 dB, no greater than 0.5 dB, no greater than 0.2 dB, or no greater than 0.1 dB. For example, a radar transmissive substrate can be transparent to the various radar frequencies. That is, a radar transmissive substrate can have a one-way radar transmission loss of no greater than 5 dB as measured by using a radar transmission system in the radar range of 76 GHZ to 81 GHZ as described below. Radar transmissive substrates may be nonmetallic and include polymeric substrates (e.g., a polymer), such as plastic, including polyester, polyolefin, polyamide, cellulosic, polystyrene, polyethylene terephthalate, polyacrylic, poly(ethylene naphthalate), polypropylene, polyethylene, nylon, ethylene vinyl alcohol copolymer, polylactic acid, other “green” polymeric substrates, polycarbonate, polycarbonate acrylobutadiene styrene, polyurethane, thermoplastic olefins, or combinations thereof. The radar transmissive substrate may be filled or unfilled plastic. A filled plastic comprises a plastic with fillers such as fibers, such as glass fibers, and/or particles, such as talc. For example, the radar transmissive substrate can comprise carbon fiber. A filled plastic may also be referred to as a composite. The radar transmissive substrate can comprise glass, wood, or a combination thereof.

The substrate layer 102 can be an automotive substrate, an industrial substrate, an architectural substrate, a coil substrate, a packaging substrate, a marine substrate, an aerospace substrate, a consumer electronic device substrate (e.g., a phone, computer, or tablet), or combinations thereof. The substrate layer 102 can be a bumper fascia, a mirror housing, a fender, a hood, a trunk, a door, the like, or a combination thereof, or an aerospace part, such as, for example, a nose cone, a radome, the like, or a combination thereof. “Automotive” as used herein refers to in its broadest sense all types of vehicles, such as, but not limited to, cars, trucks, buses, tractors, harvesters, heavy duty equipment, vans, golf carts, motorcycles, bicycles, railcars, airplanes, helicopters, boats of all sizes, and the like.

The film-forming resin can include a resin that can form a self-supporting (e.g., able to remain as a film of material with defined thickness, length and width and remains so without a supporting substrate being present) continuous film upon removal of any diluents or carriers during physical drying and/or cure at ambient or elevated temperature. “Film-forming resin” as used herein refers to resins that are self-crosslinking, resins that are crosslinked by reaction with a crosslinker, resins that solidify by cooling a heat-formed or extruded resin below a solidification temperature, or resins that form films upon solvent evaporation, setting, curing, or drying, mixtures thereof, or the like. The term “film-forming resin” can refer collectively to both a resin and crosslinker(s) therefor.

The film-forming resin can comprise at least one of a thermosetting film-forming resin and/or a thermoplastic film-forming resin. As used herein, the term “thermosetting” refers to resins that “set” irreversibly upon curing or crosslinking, where the polymer chains of the polymeric components are joined together by covalent bonds, which are often induced, for example, by heat or radiation to form a three-dimensional network. In various examples, curing or a crosslinking reaction can be carried out under ambient conditions (e.g., ambient temperature and atmospheric pressure (e.g., 1 atmosphere)). Once cured or crosslinked, a thermosetting film-forming resin may not melt upon the application of heat and can be insoluble in conventional solvents (e.g., less than 0.001 g of the material can dissolve in 1 g of the given solvent at 20° C. after 24 hours). As used herein, the term “thermoplastic” refers to resins that include polymeric components that are not joined by covalent bonds to form a three-dimensional network and thereby can undergo liquid flow upon heating and are often soluble in conventional solvents (e.g., at least 0.1 g of the material can dissolve in 1 g of the given solvent at 20° C. after 24 hours).

Thermoplastic coating compositions may include films comprising any suitable thermoplastic polymer known in the art. Suitable thermoplastic materials include, but are not limited to, polyolefins, such as high density or low density polyethylene, polypropylene, or other thermoplastic polyolefins, polystyrene, polyvinylchloride, chlorinated polyvinylchloride, polyoxymethylene, polyacrylates, such as polymethylmethacrylate, polyesters, such as polyethylene terephthalate or polylactide, polycarbonate, fluorinated thermoplastics, such as polyvinylidene fluoride, polytetrafluoroethylene, or fluorinated ethylene-propylene, polyamide, polyimide, polyamide imide, polyester imide, cellulosic thermoplastics, such as cellulose acetate, thermoplastic polyurethane or polyurea, polyphenylene oxide, polyphenylene sulfide, or polyetheretherketone.

Thermosetting coating compositions may include a crosslinking agent that may be selected from, for example, aminoplasts, polyisocyanates (including blocked isocyanates), polyepoxides, beta-hydroxyalkylamides, polyacids, anhydrides, acrylates, methacrylates, thiols, organometallic acid-functional materials, polyamines, polyamides, and mixtures of any of the foregoing.

A film-forming resin may have functional groups that are reactive with the crosslinking agent. The film-forming resin in the coatings described herein may be selected from any of a variety of polymers well known in the art. The film-forming resin may be selected from, for example, acrylic polymers, epoxy polymers, polyester polymers, polyurethane polymers, polyamide polymers, polyether polymers, polysiloxane polymers, copolymers thereof, and mixtures thereof. Generally, these polymers may be any polymers of these types made by any method known to those skilled in the art. The functional groups on the film-forming resin may be selected from any of a variety of reactive functional groups, including, for example, carboxylic acid groups, amine groups, epoxide groups, hydroxyl groups, thiol groups, carbamate groups, amide groups, urea groups, isocyanate groups (including blocked isocyanate groups), acrylate groups, or combinations thereof.

The coating compositions and the first layer 104 and/or second layer 106 formed therefrom can comprise other additives. The additives can comprise plasticizers, abrasion-resistant particles, film-strengthening particles, flow control agents, thixotropic agents, rheology modifiers, cellulose acetate butyrate, catalysts, antioxidants, biocides, defoamers, surfactants, wetting agents, dispersing aids, adhesion promoters, clays, hindered amine light stabilizers, ultraviolet (UV) light absorbers and/or stabilizers, stabilizing agents, fillers, organic cosolvents, reactive diluents, colorants such as pigments or dyes, grind vehicles, and other customary auxiliaries, or combinations thereof.

The coating composition for each layer 104 and 106, individually, can be formulated as a solvent-based composition, a water-based composition, or a 100% solid (i.e., non-volatile) composition that does not comprise a volatile solvent (e.g., readily vaporizable at ambient temperatures) or aqueous carrier. The coating composition can be a liquid at a temperature of −10° C. or greater, such as, for example, 0° C. or greater, 10° C. or greater, 30° C. or greater, 40° C. or greater, or 50° C. or greater. The coating composition can be a liquid at a temperature of 60° C. or lower, such as, for example, 50° C. or lower, 40° C. or lower, 30° C. or lower, 10° C. or lower, or 0° C. or lower. The coating composition can be a liquid at a temperature in a range of −10° C. to 60° C., such as, for example, −10° C. to 50° C., −10° C. to 40° C., −10° C. to 30° C., or 0° C. to 40° C. The coating composition can be a liquid at ambient temperature.

The second layer 106 can be selectively applied over at least a portion of the second surface 102b of the substrate 102 proximal to the radar system 108 or the second layer 106 can be applied over all of the second surface 102b. For example, “selectively applied” as used herein means the second layer 106 can be applied over less than all of the second surface 102b such as, for example, only portions of the second surface 102b that electromagnetic radiation 112 is transmitted through by the radar system 108 and/or electromagnetic radiation 114 is received through.

The second layer 106 may be applied over at least a portion of the second surface 102b at a dry film thickness, t₂, such that the second layer 106 can be configured to reduce radar transmission loss through the radar transmissive system 100 based on a permittivity (e.g., real permittivity and/or imaginary permittivity) and a thickness of the substrate layer 102 and the first layer 104. The second layer 106 can be configured to reduce radar transmission loss through the radar transmissive system 100 based on a permittivity and a thickness of each layer in the radar transmissive system 100, such as, for example, all the layers of the system 100, comprising the second layer 106, the substrate 102, the first layer 104, and any other additional layers, such as, for example, a pretreatment layer, an adhesion promoter layer, a basecoat layer, a mid-coat layer, a topcoat layer, and/or a primer layer, can form an electromagnetic stack. The electromagnetic stack receives electromagnetic waves of a specified frequency from the radar system 108 and reflects, absorbs, and transmits these waves to varying degree depending on the permittivity and thickness of each of the layers, from which the one-way transmission loss can be calculated and/or measured.

In additional or alternative examples, the second layer 106 may additionally or alternatively be applied over a front portion of the substrate, that is on an opposite side of the substrate layer 102. For example, the second layer 106 can be deposited or otherwise applied (in liquid or solid film form) on top of the first layer 104, so that the second layer 106 is between the first layer 104 and the object 110, rather than only or primarily between the radar system 108 and substrate 102, as currently shown in FIG. 1. Depositing the second layer 106 as an outer front layer (e.g., front side of a bumper) rather than as a backer layer behind the substrate 102 (e.g., inside of a bumper, between the vehicle interior and bumper) may allow for similar reduction of radar transmission loss, while also providing an opportunity to provide decoration, graphics, or other indicia that are visible or otherwise detectable on the outer side of substrate 102. However positioned, the film need only be optimized in thickness and/or permittivity of composition to ensure proper reduction of transmission loss.

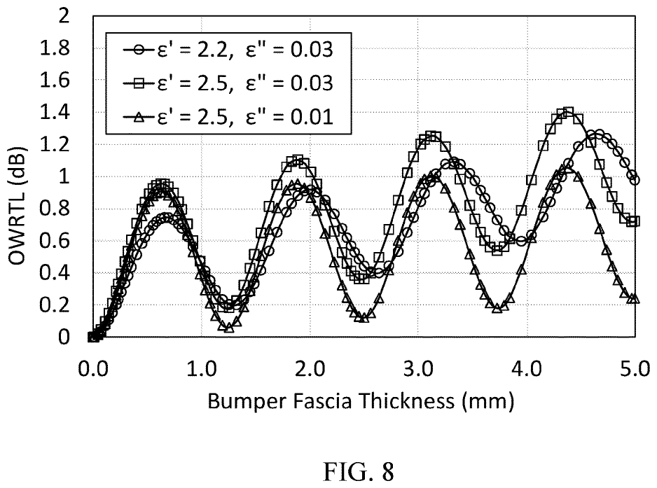

The calculation of the one-way radar transmission loss of the electromagnetic stack, based on the permittivity and thickness of each of the layers is accomplished by the transfer matrix method (TMM). The transfer matrix method can be used to calculate the transmittance and reflectance of electromagnetic waves through a stratified material as described in various references and as known by one of ordinary skill in the art. Using such transfer matrix method calculations, it was observed that radar transmission loss can occur in an approximately sinusoidal fashion relative to a thickness of a radar transmissive system 100 as shown in FIG. 8.

For example, FIG. 8 is a plot of one-way radar transmission loss based on thickness at 76.5 GHz of an uncoated substrate layer. As understood from FIG. 8, the radar loss can achieve minimal values by optimizing the thickness and permittivity of the substrate. Similarly, by tuning the thickness and permittivity of the second layer 106 by accounting for all layers in the radar transmissive system 100 can enhance the overall reduction in radar transmission loss. However, the functional dependence accounting for the thickness and permittivity of all of these layers can be more complicated than a simple single sinusoidal function. Therefore, an optimization algorithm, such as a non-linear generalized reduced gradient algorithm, can be used to minimize the radar loss of the radar transmissive system 100, by optimizing the permittivity and layer thickness of the second layer 106, for the given permittivities and thicknesses of the substrate 102 and the first layer 104 or for each layer in the radar transmissive system 100. The calculations may only take into account layers in the radar transmissive system 100 that have a significant effect on the one-way radar transmission loss of the radar transmissive system 100. A layer that has an insignificant effect on the one-way radar transmission loss of the radar transmissive system 100 can be defined as any layer for which if present vs. absent changes the one-way radar transmission loss by less than 0.05 dB.

The thickness of a layer of material can be measured with a micrometer or with a caliper or by cross sectioning a layer or stack of layers and using an optical microscope to quantify the thickness for each layer. In addition, if the material is applied to a metal panel, the thickness of the material layer can be determined using a modular coating measurement system.

One-way radar transmission loss can be measured using the above-noted radar transmission measurement system, or the above-noted R&S device setup, or other similarly configured equipment made by other manufacturers. Permittivity of a single layer of material, or of multiple layers within a multilayer stack can be measured using a radar transmission measurement set-up disclosed herein by knowing an accurate thickness for each layer in the stack and the one-way radar transmission loss of the layer or stack of layers, by calculating the permittivity of one or more layers with their given thicknesses that gives the same one-way radar transmission loss by calculation (such as by transfer matrix method calculation) as the measured one-way radar transmission loss, for instance by minimization of the root-mean square error (RMSE) between the measured one-way radar transmission loss and the calculated one-way radar transmission loss when the permittivity values are the varied to minimize the root mean square error.

To increase the accuracy of permittivity measurement using the above-noted R&S device setup, the one-way radar transmission loss can be measured over multiple frequencies, such as from 60 GHz to 90 GHz or from 76 GHz to 81 GHz. If the thickness of each layer is known only approximately, then using the R&S device, the permittivity of a single layer of material, or of multiple layers within a multilayer stack can be measured by measuring the one-way radar transmission loss of the layer or stack of layers and then calculating the permittivity of one or more layers with their associated thicknesses that gives the same one-way radar transmission loss by calculation as the measured one-way radar transmission loss, for instance by minimization of the root mean square error between the measured one-way radar transmission loss and the calculated one-way radar transmission loss when the permittivity values and the thickness values are varied to minimize the root mean square error, and the validity of this process is checked, ensuring that the resulting layer thicknesses from the minimization process, which can vary the layer thicknesses, are only different from the measured input values by a value that is consistent with the physical variation of the thickness of these layers and the experimental uncertainty of their measured values.

The dry film thickness, t₂, of the second layer 106 can be at least λ/400, such as, for example, at least λ/80, or at least λ/40. The dry film thickness, t₂, of the second layer 106 can be no greater than λ/2, such as, for example, no greater than λ/3, no greater than λ/4, or no greater than λ/5, where λ is the wavelength of the radar frequency of interest. For instance, the dry film thickness, t₂, of the second layer 106 can be in a range of 10 μm to 2000 μm, such as, for example, 50 μm to 1500 μm, or 100 μm to 1000 μm. The second layer 106 can have a uniform dry film thickness where the dry film thickness, t₂, across the second layer 106 does not vary more than 20%, such as by no more than 10% of the average thickness of the second layer 106.

The dry film thickness, t₁, of the first layer 104, can be at least 5 μm, such as, for example, at least 10 μm, at least 20 μm, at least 30 μm, or at least 100 μm. The dry film thickness, t₁, of the first layer 104, can be no greater than 1000 μm, such as, for example, no greater than 500 μm, no greater than 200 μm, no greater than 100 μm, no greater than 80 μm. The dry film thickness, t₁, of the first layer 104, can be in a range of 5 μm to 1000 μm, such as, for example, 5 μm to 500 μm, 5 μm to 200 μm, 5 μm to 100 μm, 10 μm to 100 μm, or 10 μm to 80 μm.

The thickness, tₛ, of the substrate layer 102 can be at least 0.5 mm, such as, for example, at least 2 mm, or at least 2.5 mm. The thickness, tₛ, of the substrate layer 102 can be no greater than 10 mm, such as, for example, no greater than 5 mm, no greater than 4 mm, or no greater than 3.5 mm. The thickness, tₛ, of the substrate layer 102 can be in a range of 0.5 mm to 10 mm, such as, for example, 2 mm to 5 mm, 2.5 mm to 4 mm, or 2.5 mm to 3.5 mm.

The permittivity, εₛ, (i.e., real permittivity), of the substrate layer 102 can be greater than the permittivity, ε₂, of the second layer 106; the permittivity, εₛ, of the substrate layer 102 can be less than the permittivity, ε₂, of the second layer 106; or the permittivity, εₛ, of the substrate layer 102 can be the same as the permittivity, ε₂, of the second layer 106. A difference between the permittivity, εₛ, of the substrate layer 102 and the permittivity, ε₂, of the second layer 106 can be no greater than 0.5, and can be, for example, no greater than 0.4, no greater than 0.3, no greater than 0.2, or no greater than 0.1, all as measured with aforementioned permittivity measurement system at a frequency in range of 76 GHz to 81 GHz. A difference between the permittivity, εₛ, of the substrate layer 102 and the permittivity, ε₂, of the second layer 106 can be 0.5 or greater, and can be, for example, 0.75 or greater, 1.0 or greater, 1.5 or greater, 2.0 or greater, 4.0 or greater, or 8.0 or greater at 76 GHz to 81 GHz.

The permittivity, εₛ, of the substrate layer 102 can be at least 1, and can be, for example, at least 1.5, at least 1.8, or at least 2, all as measured with a permittivity measurement system at a frequency in range of 76 GHz to 81 GHz. The permittivity, εₛ, of the substrate layer 102 can be no greater than 10, and can be, for example, no greater than 7.5, no greater than 5, or no greater than 4, all as measured with a permittivity measurement system at a frequency in range of 76 GHz to 81 GHz. The permittivity, εₛ, of the substrate layer 102 can be in a range of 1 to 10, and can be in the range of, for example, 1 to 5, 1 to 4, 1.5 to 5, or 1.5 to 4, all as measured with a permittivity measurement system at a frequency in range of 76 GHz to 81 GHz.

The permittivity, ε₂, (i.e., real permittivity) of the second layer 106 can be at least 1, and can be, for example, at least 1.5, at least 1.8, or at least 2, all as measured with a permittivity measurement system at a frequency in range of 76 GHz to 81 GHz. The permittivity, ε₂, of the second layer 106 can be no greater than 30, and can be, for example, no greater than 20, no greater than 15, or no greater than 10, all as measured with a permittivity measurement system at a frequency in range of 76 GHz to 81 GHz. For example, the permittivity, ε₂, of the second layer 106 can be in a range of 1 to 30, and can be in the range of, for example, 1 to 20, 1 to 10, or 1.5 to 10, all as measured with a permittivity measurement system at a frequency in range of 76 GHz to 81 GHz. To minimize the radar transmission loss through a given layer, it is preferable to minimize the imaginary part of the permittivity (ε″) of the given layer. The imaginary part of the permittivity for the second layer 106 can be less than 2.0, such as less than 1.0, such as less than 0.5, such as less than 0.2.

Furthermore, the second layer can comprise a film-forming resin having a real permittivity as measured at a frequency in a range of 76 GHz to 81 GHz of 2.0 or greater, such as 2.5 or greater. Similarly, the second layer can comprise a film-forming resin having an imaginary part of the permittivity as measured at a frequency in a range of 76 GHz to 81 GHz of no greater than 1.0, such as no greater than 0.5.

The permittivity, ε₁, (i.e., real permittivity) of the first layer 104 can be at least 1.5, and can be, for example, at least 1.8, or at least 2, all as measured with a permittivity measurement system at a frequency in range of 76 GHz to 81 GHz. The permittivity, ε₁, of the first layer 104 can be no greater than 120, and can be, for example, no greater than 60, no greater than 40, or no greater than 30, all as measured with a permittivity measurement system at a frequency in range of 76 GHz to 81 GHz. The permittivity, ε₁, of the first layer 104 can be in a range of 1.5 to 120, and can be in the range of, for example, 1.5 to 60, 1.5 to 60, 1.5 to 40, 2 to 40, or 2 to 30, all as measured with a permittivity measurement system at a frequency in range of 76 GHz to 81 GHz.

One-way radar transmission loss, as set forth below, can quantify the radar transmission loss, if any, of radar transmitted through the radar transmission system 100, such as at a frequency range of 76 GHz to 81 GHz and a measurement accuracy of +/−0.1 dB.

The radar transmission loss in dB can be calculated with Equation 2.

$$one - way radar transmission loss ( dB ) = free space transmission ( dBm ) - sample transmission ( dBm ) \qquad Equation 2$$

The radar transmission loss is related to the % Transmittance (% T) of a radar signal by Equation 3.

$$\% T = 100 \times 1 {0}^{- ( OWRTL / 10 )} \qquad Equation 3$$

The radar transmissive system 100 can transmit 50% or greater of electromagnetic radiation comprising a frequency of 1 GHz to 300 GHz (e.g., have a one-way radar transmission loss (% T) of 50% or greater), such as, 1 GHz to 100 GHz or 76 GHz to 81 GHz, through the radar transmissive system, such as, 60% or greater, 70% or greater, 75% or greater, 80% or greater, 85% or greater, or 90% or greater of electromagnetic radiation comprising a frequency in a range of 1 GHz to 300 GHz, such as, 1 GHz to 100 GHz or 76 GHz to 81 GHZ, through the radar transmissive system 100. The 76 GHz to 81 GHz frequency range (e.g., 77 GHz) can be utilized for automotive radar and other radar applications. For example, the radar transmissive system 100 can transmit 50% or greater of electromagnetic radiation at a specific frequency and/or for all frequencies in a range of 1 GHz to 300 GHz, as desired, such as, for example, at a frequency of 76 GHZ, 76.5 GHZ, and/or 81 GHz.

The present disclosure provides an assembly comprising the radar transmissive system 100 and the radar system 108. The radar system 108 can be configured for various uses, including blind spot detection, lane change assistance, collision mitigation, collision warning, parking aid, rear cross track alert, adaptive cruise, pre-crash, back up parking aid, rear crash avoidance, other functions, or a combination thereof. The radar system 108 can detect a distance between the radar system 108 and another object 110. The radar system 108 can be, for example, a direct propagation radar system, an indirect propagation radar system, phased array radar, monostatic radar, bistatic radar, pulsed radar, continuous wave (CW) radar, frequency modulated continuous wave (FMCW) radar, 4D radar, or a combination thereof.

The radar system 108 can be configured to transmit electromagnetic radiation 112 through the radar transmissive system 100 and receive electromagnetic radiation 114 reflected by an object 110. The radar system 108 may be positioned proximal to and/or adjacent to the second layer 106. The radar system can transmit electromagnetic radiation 112 that can traverse through the radar transmissive system 100. The radar transmissive system 100 can minimally, if at all, reduce the transmission of the electromagnetic radiation 112 therethrough such that the electromagnetic radiation 112 can exit the radar transmissive system 100. The electromagnetic radiation 112 that exits the radar transmissive system 100 can be used for the detection of an object 110. For example, the electromagnetic radiation 112 can reflect off of the object 110 and return as electromagnetic radiation 114 through the radar transmissive system 100 to the radar system 108.

The present disclosure provides a method of making the radar transmissive system 100. The method can comprise depositing the first layer 104 over the first surface 102a of the substrate 102. A desired dry film thickness of the second layer 106 can be selected based on the permittivity and thickness of the substrate layer 102 and the first layer 104 such that radar transmission loss through the radar transmissive system 100 can be reduced. For example, a desired dry film thickness and permittivity of the second layer 106 can be selected based on the permittivity and thickness of each layer in the radar transmissive system 100, which may additionally comprise a pretreatment layer, an adhesion promoter layer, a basecoat layer, a mid-coat layer, a topcoat layer, and/or a primer layer. The second layer 106 can be deposited at the selected desired film thickness, over the second surface 102b of the substrate layer 102 to reduce radar transmission loss through the radar transmissive system 100.

The first layer 104 and/or second layer 106 can be deposited by depositing a coating composition for the first layer 104 and/or the second layer 106 using at least one of spray coating, spin coating, dip coating, roll coating, flow coating, slot die coating, brush coating, in-mold coating, film coating, extruding, and dispensing (e.g., ribbon dispensing). The coating composition may be manufactured as a preformed film and thereafter applied over at least a portion of the substrate layer 102. After depositing the coating composition over the substrate layer 102, the coating composition may be allowed to coalesce to form a substantially continuous film on the substrate layer, and the coating composition can be cured to form the first layer 104 and/or the second layer 106. The coating composition can be cured at a temperature of −10° C. or greater, such as, for example, 10° C. or greater. The coating composition can be cured at a temperature of 175° C. or lower, such as, for example, 120° C. or lower, such as 100° C. or lower. The coating composition can be cured at a temperature in a range of −10° C. to 175° C. The curing can comprise a thermal bake (e.g., 80° C. or more, 100° C. or more, 140° C. or more) in an oven. The coating may also be cured by application of other stimuli, such as ultraviolet irradiation, electron beam irradiation, infrared irradiation, or other stimuli known in the art.

The substrate layer 102 can be at least partially coated with the coating composition. For example, the coating composition for the first layer 104 and the second layer 106, individually, can be applied over 1% or greater of the respective surface 102a or 102b of the substrate layer 102, such as, for example, 10% or greater, 20% or greater, 50% or greater, 70% or greater, 90% or greater, or 99% or greater of the respective surface 102a or 102b of the substrate layer 102. The coating composition for the first layer 104 and the second layer 106, individually, can be applied over 100% or lower of the respective surface 102a or 102b of the substrate layer 102, such as, for example, 99% or lower, 90% or lower, 70% or lower, 50% or lower, 20% or lower, or 10% or lower of the respective surface 102a or 102b of the substrate layer 102. The coating composition for the first layer 104 and the second layer 106, individually, can be applied over 1% to 100% of the respective surface 102a or 102b of the substrate layer 102, such as, for example, 5% to 99%, 5% to 90%, 5% to 70%, 5% to 20%, or 50% to 100% of the respective surface 102a or 102b of the substrate layer 102.

The present disclosure also provides a method for improving radio detection and ranging in an electromagnetic radiation frequency range of 1 GHz to 300 GHz, such as, 1 GHZ to 100 GHz or 76 GHz to 81 GHz, with radar systems that are mounted behind coated articles. The method comprises positioning the radar transmissive system 100 proximal to the radar system 108 such that the radar system 108 transmits electromagnetic radiation 112 through the radar transmissive system 100. The improvement can be relative to the coated article without the second layer 106.

The radar transmissive system 100 can optionally further comprise a pretreatment layer, an adhesion promoter layer, a basecoat layer, a mid-coat layer, a topcoat layer, a primer layer, or a combination thereof applied over at least a portion of the first surface 102a. For example, there may be a single-layer or a multilayer coating stack applied over at least a portion of the first surface 102a, such as a multilayer coating stack including at least two layers, the first layer 104 and a secondary layer underneath or on top of at least a portion of the first layer. Additional layers, such as, for example, a pretreatment layer, an adhesion promoter layer, a basecoat layer, a mid-coat layer, a topcoat layer (e.g., clear coat, tinted clear coat), a primer layer, or combinations thereof, may be deposited before or after the first layer 104. The tinted clear coat can be, for example, a clear coat to which dyes and/or pigments, such as nano-sized pigment dispersions, are added. The tinted clear coat can comprise nano-sized pigment dispersions with an average primary particle size of less than 150 nm as measured with transmission electron microscopy (TEM, or an electronic microscope), such as, for example, less than 100 nm as measured with an electron microscope. The nano-sized pigment dispersions can have an average primary particle size in a range of 20 nm to 150 nm, such as, for example, 20 nm to 100 nm, 20 nm to 80 nm, 20 nm to 60 nm, or 20 nm to 40 nm. For example, the nano-sized pigments dispersions can have an average primary particle size of 25 nm, 35 nm, or 50 nm. As used herein, average particle size is measured with an electron microscope refers to the average Feret diameter of the particle as measured by electron microscope.

A coating stack for use in automotive applications may comprise an adhesion promoter layer applied over at least a portion the substrate layer 102, optionally a primer layer disposed over the adhesion promoter layer, a basecoat layer disposed over the primer layer and/or adhesion promoter layer, and a clear coat disposed over the basecoat layer. The first layer 104 can be the adhesion promoter layer, the primer layer, the basecoat layer, or the clearcoat layer.

A coating stack as applied over at least a portion of the substrate layer 102, such as, for example, in automotive refinish or aerospace applications, may comprise an optional pretreatment layer and/or adhesion promoter layer, optionally a primer layer, a basecoat layer, and a clear coat. A coating stack as applied over at least a portion of the substrate layer 102, such as, for example, in automotive refinish, general industrial, or aerospace applications, can comprise an optional pretreatment or adhesion promoter layer, a primer layer, and a direct gloss topcoat layer. A direct gloss topcoat layer means a layer comprising both the color and desired gloss in one coating that is typically the last applied coating of a coating stack. An additional clear coat can optionally be applied over at least a portion of a direct gloss topcoat layer.

The first layer 104 or the second layer 106 may comprise a film. The film can be a multilayer film comprising at least two layers, including a first film layer comprising a thermoset or thermoplastic layer and an optional adhesive layer, such as a pressure sensitive adhesive. The adhesive layer can be protected with a removable layer or release liner that would be removed prior to application of the film to a substrate. The first film layer may be applied over at least a portion of a carrier film that would support the first film layer until the first film layer is formed, and thereafter the carrier film may optionally be removed. The first film layer may be applied over at least a portion of a protective clear film that itself may be on a carrier film. The protective clear film may be thermoset or thermoplastic and would be the top layer when the multilayer film is applied over at least a portion of the substrate 102 via contact of the adhesive layer with the substrate 102. A layer of the multilayer film may comprise thermoset or thermoplastic polyurethane, thermoplastic polyolefin, or any other appropriate film forming material known in the art. In some cases, the film composition will additionally comprise fillers or pigments as described above. The first film layer of the film may be spray applied, extruded, formed, laminated, or polymerized in situ, or otherwise deposited to an adjacent layer of a multilayer film or to a removable layer. In some cases, the film layer may comprise at least three layers, comprising a clearcoat layer, a thermoset or thermoplastic layer, and an adhesive layer.

An air egress channel may be present intermediate the second layer 106 and the substrate layer 102. A coating stack with an air egress channel may comprise an adhesive applied over at least a portion of the film, air egress channels over the adhesive, and a substrate over the air egress channels.

In-mold coating (IMC) is an alternative to painting for injection molded plastic parts. IMC can be done by applying a coating composition by spraying, injecting or other known means in the art, onto the surface of the article of manufacture while it is still in the mold. The coating then solidifies and adheres to the article. A coating composition or film can be applied in mold prior to injection molding of an article of manufacture such that the coating or film is applied over at least a portion of the surface of the molded article or manufacture. Both methods are IMC according to the present disclosure, and may be used for the application of the first layer 104 and/or second layer 106.

As used herein, unless otherwise expressly specified, all numbers, such as those expressing values, ranges, amounts, or percentages, may be read as if prefaced by the word “about,” even if the term does not expressly appear. Any numerical range recited herein is intended to include all sub-ranges subsumed therein. The plural encompasses the singular and vice versa. For example, while the present disclosure has been described in terms of “a” layer, “a” substrate, “a” radar transmissive substrate, “a” pigment, and the like, more than one of these and other components, including mixtures, can be used. When ranges are given, any endpoints of those ranges and/or numbers within those ranges can be combined with the scope of the present disclosure. “Including,” “such as,” “for example,” and like terms mean “including/such as/for example but not limited to.”

Also, as used herein, the term “polymer” is meant to refer to prepolymers, oligomers, and both homopolymers and copolymers; and the prefix “poly” refers to two or more. The terms “acrylic” and “acrylate” are used interchangeably (unless to do so would alter the intended meaning) and include acrylic acids, anhydrides, and derivatives thereof, lower alkyl-substituted acrylic acids, e.g., C₁-C₂ substituted acrylic acids, such as methacrylic acid, ethacrylic acid, etc., and their C₁-C₆ alkyl esters and hydroxyalkyl esters, unless clearly indicated otherwise.

As used in this specification, the terms “cure” and “curing” refer to the chemical crosslinking of components in a coating composition applied as a layer over a substrate. Accordingly, the terms “cure” and “curing” do not encompass solely physical drying of coating compositions through solvent or carrier evaporation. In this regard, the term “cured,” as used in this specification, refers to the condition of a layer in which a component of the coating composition forming the layer has chemically reacted to form new covalent bonds in the layer (e.g., new covalent bonds formed between a binder resin and a curing agent).

As used in this specification, the term “formed” refers to the creation of an object from a composition by a suitable process, such as, curing. For example, a coating formed from a curable coating composition refers to the creation of a single or multiple layered coating or coated article from the curable coating composition by curing the coating composition under suitable process conditions.

### EXAMPLES

The present disclosure will be more fully understood by reference to the following examples, which provide illustrative non-limiting aspects of the disclosure. It is understood that the disclosure described in this specification is not necessarily limited to the examples described in this section.

As used herein, the term “parts” refers to parts by weight unless indicated to the contrary.

Permittivity was measured with a suitable device as outlined herein

### Calculated Examples 1-18

Examples 1-18 illustrate % T through substrate layers of thermoplastic polyolefin (TPO) panels (LYONDELL BASELL HIFAX TRC779X, 4 inches×12 inches×nominal 0.118 inch, available from STANDARD PLAQUE INC.) without a second layer (also referred to as a backer layer in the Examples) compared to different configurations of applying various types of backer layers (e.g., second layer 106) applied over a second surface (e.g., second surface 102b) of the TPO panels (e.g., substrate layer 102). All TPO Panels were considered to be coated on a first surface (e.g., first surface 102a) of the TPO panels with a first layer (e.g., first layer 104, also referred to as basecoat layers in the Examples) with a range of permittivity values. Table 1 shows various parameters for the TPO panel and basecoat layers that were used to evaluate the test methods for creating a radar transmissive system according to the present disclosure including the permittivity of the TPO panels (which was measured by an RMS-D from PERISENS, GMBH) the permittivity of the basecoat layer applied over the first surface of the TPO panels, the thickness of the TPO panels as measured with a caliper, and the dry film thickness of the basecoat layer. The same type of TPO panel was used for each test condition.

TABLE 1
Parameters for the substrate and base coat layer

| | Substrate and BC Parameters | | | | | |
|---|---|---|---|---|---|---|
| | | | d_{SB} | | | d_{BC} |
| Condition | ε′_{SB} | ε″_{SB} | (μm) | ε′_{BC} | ε″_{BC} | (μm) |
| A1 | 2.466 | 1E−04 | 2850 | 2 | 0 | 15 |
| A2 | 2.466 | 1E−04 | 2850 | 5 | 0 | 15 |
| A3 | 2.466 | 1E−04 | 2850 | 10 | 0 | 15 |
| A4 | 2.466 | 1E−04 | 2850 | 20 | 0 | 15 |
| A5 | 2.466 | 1E−04 | 2850 | 40 | 0 | 15 |
| A6 | 2.466 | 1E−04 | 2850 | 50 | 0 | 15 |
| B1 | 2.466 | 1E−04 | 2850 | 2 | 0.5 | 15 |
| B2 | 2.466 | 1E−04 | 2850 | 5 | 0.5 | 15 |
| B3 | 2.466 | 1E−04 | 2850 | 10 | 0.5 | 15 |
| B4 | 2.466 | 1E−04 | 2850 | 20 | 0.5 | 15 |
| B5 | 2.466 | 1E−04 | 2850 | 40 | 0.5 | 15 |
| B6 | 2.466 | 1E−04 | 2850 | 50 | 0.5 | 15 |
| C1 | 2.466 | 1E−04 | 2850 | 2 | 3 | 15 |
| C2 | 2.466 | 1E−04 | 2850 | 5 | 3 | 15 |
| C3 | 2.466 | 1E−04 | 2850 | 10 | 3 | 15 |
| C4 | 2.466 | 1E−04 | 2850 | 20 | 3 | 15 |
| C5 | 2.466 | 1E−04 | 2850 | 40 | 3 | 15 |
| C6 | 2.466 | 1E−04 | 2850 | 50 | 3 | 15 |

_{SB}= Substrate Layer
_{BC}= Basecoat (e.g., First Layer)
ε′_{SB} = real part of the permittivity of the substrate
ε″_{SB} = imaginary part of the permittivity of the substrate
ε′_{BC} = real part of the permittivity of the basecoat
ε″_{BC} = imaginary part of the permittivity of the basecoat
d_{SB} = thickness of the substrate
d_{BC} = thickness of the basecoat.

The design parameters for a backer layer were calculated using various methods at a radar frequency of 76.5 GHZ. Then the one-way radar transmission loss and percent transmittance was calculated for the various example systems as shown in Table 2 using transfer matrix method calculations, such as available in spreadsheet application programs, including but not limited to MICROSOFT EXCEL.

### Design Methods for a Backer Layer

Control Method A—The one-way radar transmission loss was determined without a backer layer applied over the back side of the TPO panel.

Method B—The permittivity of the backer layer was set to be the same as the permittivity of the TPO panel and only the thickness of the backer layer was optimized according to the present disclosure using the permittivity and thickness of each layer in the example system. The optimization was performed using transfer matrix method calculations and the Solver function in MICROSOFT EXCEL, employing the non-linear generalized reduced gradient algorithm within the MICROSOFT EXCEL Solver to find the thickness of the backer layer that achieves a reduced one-way radar transmission loss for the system. Specifically, within the MICROSOFT EXCEL Solver, the value of one-way radar transmission loss was minimized by varying the value for the thickness of the backer layer. The MICROSOFT EXCEL Solver routine minimized the value of the one-way transmission loss and reported the thickness of the backer layer that achieved this minimum. As with the results of many minimization algorithms, the minimized one-way radar transmission loss may not be the lowest possible value, but is none-the-less a reduced value of the one-way radar transmission loss (for instance this minimized value would preferably be a global minimum, but may be only a local minimum).

Method C—The permittivity of the backer layer and thickness of the backer layer were optimized according to the present disclosure using the permittivity and thickness of each layer in the example system. The optimization was performed using transfer matrix method calculations and the Solver function in MICROSOFT EXCEL, employing the non-linear generalized reduced gradient algorithm within the MICROSOFT EXCEL Solver to find the thickness and permittivity of the backer layer that achieves a reduced one-way radar transmission loss for the system. Specifically, within the MICROSOFT EXCEL Solver, the value of one-way radar transmission loss was minimized by varying the values for the thickness and the permittivity of the backer layer. The MICROSOFT EXCEL Solver routine minimized the value of the one-way radar transmission loss and reported the thickness and permittivity of the backer layer that achieved this minimum. As with the results of many minimization algorithms, the minimized one-way radar transmission loss may not be the lowest possible value, but is nonetheless a reduced value of the one-way radar transmission loss (for instance this minimized value would preferably be a global minimum, but may be only a local minimum).

Comparative Method D—The backer layer was set to be the same permittivity and thickness as the base coat layer on the front side of the TPO panel. Where used in the literature, this method does not mention the imaginary part of the permittivity of the layers, but as this is necessary for accurate calculation of radar transmission; the present disclosure includes these imaginary values where pertinent.

Comparative Method E—In this method, only the permittivity and thickness of the substrate is considered. The thicknesses and permittivities of the other layers in the stack are not considered. The following conditions were set for Comparative Method E: ε′_{BL}=(ε′_{SB})^{1/2} and d_{BL}=λ(4(ε′_{BL})^{1/2}. Conventional methods such as this do not mention the imaginary part of the permittivity of the layers; but this can be important in the present disclosure in some cases in order to calculate accurate radar transmission. Accordingly, the present disclosure includes these imaginary values where pertinent.

TABLE 2
Examples 1-18; 76.5 GHz

| | | Method | | | | | | | | | | | | | | | | |
|---|---|---|---|---|---|---|---|---|---|---|---|---|---|---|---|---|---|---|
| | | | B | | | | C | | | | D | | | | E | | | |
| | | A | | | d_{BL} | | | | d_{BL} | | | | d_{BL} | | | | d_{BL} | |
| Ex. | Cond. | % T | ε′_{BL} | ε″_{BL} | (μm) | % T | ε′_{BL} | ε″_{BL} | (μm) | % T | ε′_{BL} | ε″_{BL} | (μm) | % T | ε′_{BL} | ε″_{BL} | (μm) | % T |
| 1 | A1 | 87.9 | 2.466 | 1E−04 | 883 | 100.0 | 2.465 | 0 | 883 | 100.0 | 2 | 0 | 15 | 87.5 | 1.570 | 0 | 782 | 95.1 |
| 2 | A2 | 86.6 | 2.466 | 1E−04 | 852 | 100.0 | 2.479 | 0 | 851 | 100.0 | 5 | 0 | 15 | 85.0 | 1.570 | 0 | 782 | 95.0 |
| 3 | A3 | 84.2 | 2.466 | 1E−04 | 804 | 99.9 | 2.546 | 0 | 797 | 100.0 | 10 | 0 | 15 | 81.1 | 1.570 | 0 | 782 | 94.5 |
| 4 | A4 | 79.0 | 2.466 | 1E−04 | 722 | 99.6 | 2.789 | 0 | 691 | 100.0 | 20 | 0 | 15 | 74.4 | 1.570 | 0 | 782 | 92.4 |
| 5 | A5 | 67.8 | 2.466 | 1E−04 | 616 | 96.3 | 3.626 | 0 | 506 | 100.0 | 40 | 0 | 15 | 66.6 | 1.570 | 0 | 782 | 84.3 |
| 6 | A6 | 62.2 | 2.466 | 1E−04 | 581 | 93.1 | 4.254 | 0 | 427 | 100.0 | 50 | 0 | 15 | 65.6 | 1.570 | 0 | 782 | 79.1 |
| 7 | B1 | 87.1 | 2.466 | 1E−04 | 883 | 98.8 | 2.419 | 0 | 887 | 98.8 | 2 | 0.5 | 15 | 86.0 | 1.570 | 0 | 782 | 94.2 |
| 8 | B2 | 85.8 | 2.466 | 1E−04 | 852 | 98.8 | 2.438 | 0 | 854 | 98.8 | 5 | 0.5 | 15 | 83.7 | 1.570 | 0 | 782 | 94.1 |
| 9 | B3 | 83.5 | 2.466 | 1E−04 | 803 | 98.8 | 2.510 | 0 | 799 | 98.8 | 10 | 0.5 | 15 | 79.9 | 1.570 | 0 | 782 | 93.6 |
| 10 | B4 | 78.4 | 2.466 | 1E−04 | 720 | 98.5 | 2.757 | 0 | 692 | 98.8 | 20 | 0.5 | 15 | 73.4 | 1.570 | 0 | 782 | 91.5 |
| 11 | B5 | 67.3 | 2.466 | 1E−04 | 615 | 95.4 | 3.593 | 0 | 507 | 98.8 | 40 | 0.5 | 15 | 66.0 | 1.570 | 0 | 782 | 83.6 |
| 12 | B6 | 61.8 | 2.466 | 1E−04 | 580 | 92.2 | 4.217 | 0 | 427 | 98.8 | 50 | 0.5 | 15 | 65.0 | 1.570 | 0 | 782 | 78.5 |
| 13 | C1 | 83.5 | 2.466 | 1E−04 | 883 | 93.1 | 2.220 | 0 | 902 | 93.2 | 2 | 3 | 15 | 79.0 | 1.570 | 0 | 782 | 89.9 |
| 14 | C2 | 82.3 | 2.466 | 1E−04 | 849 | 93.1 | 2.257 | 0 | 866 | 93.2 | 5 | 3 | 15 | 77.2 | 1.570 | 0 | 782 | 89.9 |
| 15 | C3 | 80.2 | 2.466 | 1E−04 | 795 | 93.2 | 2.347 | 0 | 806 | 93.3 | 10 | 3 | 15 | 74.2 | 1.570 | 0 | 782 | 89.4 |
| 16 | C4 | 75.5 | 2.466 | 1E−04 | 710 | 93.2 | 2.612 | 0 | 695 | 93.3 | 20 | 3 | 15 | 68.9 | 1.570 | 0 | 782 | 87.5 |
| 17 | C5 | 65.2 | 2.466 | 1E−04 | 606 | 90.7 | 3.442 | 0 | 509 | 93.3 | 40 | 3 | 15 | 62.6 | 1.570 | 0 | 782 | 80.3 |
| 18 | C6 | 60.6 | 2.466 | 1E−04 | 573 | 88.0 | 4.049 | 0 | 430 | 93.3 | 50 | 3 | 15 | 61.8 | 1.570 | 0 | 782 | 75.5 |

_{BL}= Backer Layer
ε′_{BL} = real part of the permittivity of the backer layer
ε″_{BL} = imaginary part of the permittivity of the backer layer
d_{BL} = thickness of the backer layer

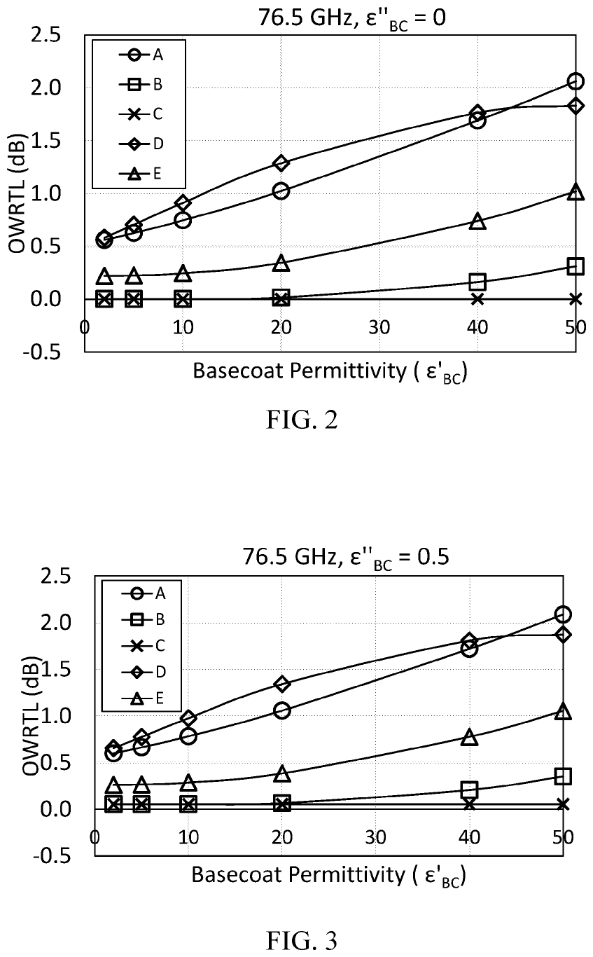

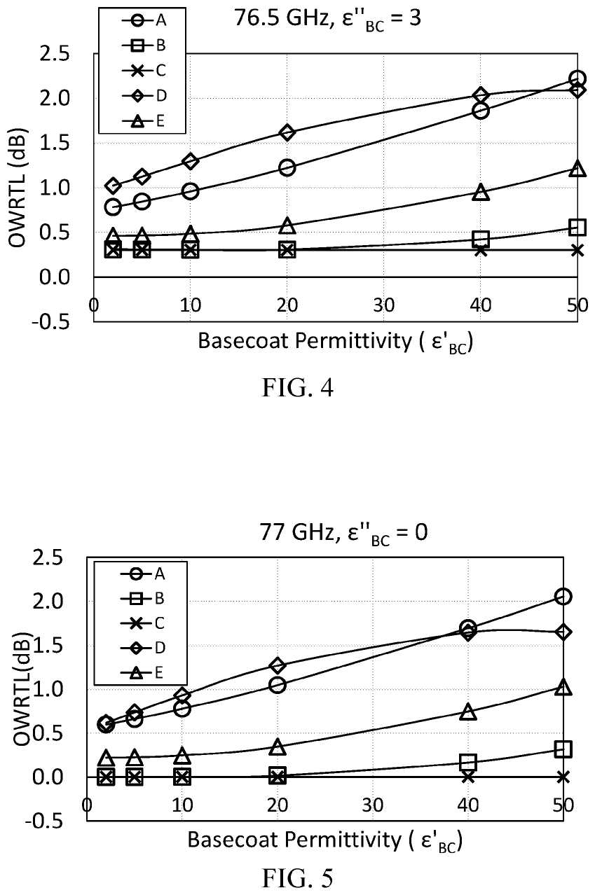

The results illustrated in Table 2 and plotted in FIGS. 2-4 demonstrate that as basecoat permittivity increases, the radar transmission drops dramatically without a backer layer as shown using Control Method A. For example, FIG. 2 is a plot of one-way radar transmission loss (OWRTL, or transmission loss, or one-way transmission loss) at 76.5 GHz of Examples 1-6 using methods A-E according to the Examples described herein with basecoats having an imaginary part of their permittivity values equal to 0, and for a substrate thickness of 2850 μm. In addition, FIG. 3 is a plot of one-way radar transmission loss at 76.5 GHz of Examples 7-12 using methods A-E according to the Examples described herein with basecoats having an imaginary part of their permittivity values equal to 0.5, and for a substrate thickness of 2850 μm. Furthermore, FIG. 4 is a plot of one-way radar transmission loss at 76.5 GHz of Examples 13-18 using methods A-E according to the Examples described herein with a basecoat having an imaginary part of their permittivity values equal to 3, and for a substrate thickness of 2850 μm.

Method C showed excellent radar transmission compared to having no backer layer using Control Method A, and to Comparative Method D and Comparative Method E. Method B demonstrated very good radar transmission, while Comparative Method D and Comparative Method E show mediocre to poor radar transmission, even worse than having no backer layer (Control Method A) in some cases. FIGS. 2-4 also demonstrate that the main effect of the imaginary part of the basecoat permittivity, is to increase the overall radar transmission loss, regardless of the value of the real part of the basecoat permittivity, and that the trends in affecting the radar transmission using a backer layer remain very similar over a range of values for ε″_{BC}.

### Calculated Examples 19-36

Examples 19-36 show calculated radar loss results completed in the same fashion as in Examples 1-18, except the radar frequency is 77 GHz. The data in Table 3 and plotted in FIG. 5 demonstrate the same trends as in Examples 1-18. In particular, FIG. 5 is a plot of one-way radar transmission loss at 77 GHz of Examples 19-24 using methods A-E according to the Examples described herein with basecoats having an imaginary part of their permittivity values equal to 0, and for a substrate thickness of 2850 μm. As shown, Method C exhibits excellent radar transmission compared to having no backer layer using Control Method A and to Comparative Method D and Comparative Method E. Method B demonstrated very good radar transmission, while Comparative Method D and Comparative Method E show mediocre to poor radar transmission, even worse than having no backer layer (Control Method A) in some cases.

TABLE 3
Examples 19-36; 77 GHz

| | | Method | | | | | | | | | | | | | | | | |
|---|---|---|---|---|---|---|---|---|---|---|---|---|---|---|---|---|---|---|
| | | | B | | | | C | | | | D | | | | E | | | |
| | | A | | | d_{BL} | | | | d_{BL} | | | | d_{BL} | | | | d_{BL} | |
| Ex. | Cond. | % T | ε′_{BL} | ε″_{BL} | (μm) | % T | ε′_{BL} | ε″_{BL} | (μm) | % T | ε′_{BL} | ε″_{BL} | (μm) | % T | ε′_{BL} | ε″_{BL} | (μm) | % T |
| 19 | A1 | 87.1 | 2.466 | 1E−04 | 859 | 100.0 | 2.465 | 0 | 859 | 100.0 | 2 | 0 | 15 | 86.8 | 1.570 | 0 | 777 | 95.1 |
| 20 | A2 | 85.9 | 2.466 | 1E−04 | 828 | 100.0 | 2.479 | 0 | 827 | 100.0 | 5 | 0 | 15 | 84.4 | 1.570 | 0 | 777 | 95.0 |
| 21 | A3 | 83.6 | 2.466 | 1E−04 | 780 | 99.9 | 2.544 | 0 | 773 | 100.0 | 10 | 0 | 15 | 80.7 | 1.570 | 0 | 777 | 94.5 |
| 22 | A4 | 78.6 | 2.466 | 1E−04 | 698 | 99.6 | 2.784 | 0 | 666 | 100.0 | 20 | 0 | 15 | 74.7 | 1.570 | 0 | 777 | 92.3 |
| 23 | A5 | 67.7 | 2.466 | 1E−04 | 593 | 96.3 | 3.648 | 0 | 479 | 100.0 | 40 | 0 | 15 | 68.5 | 1.570 | 0 | 777 | 84.2 |
| 24 | A6 | 62.3 | 2.466 | 1E−04 | 558 | 93.0 | 4.322 | 0 | 398 | 100.0 | 50 | 0 | 15 | 68.4 | 1.570 | 0 | 777 | 78.9 |
| 25 | B1 | 86.4 | 2.466 | 1E−04 | 859 | 98.8 | 2.422 | 0 | 862 | 98.8 | 2 | 0.5 | 15 | 85.3 | 1.570 | 0 | 777 | 94.2 |
| 26 | B2 | 85.2 | 2.466 | 1E−04 | 828 | 98.8 | 2.440 | 0 | 830 | 98.8 | 5 | 0.5 | 15 | 83.1 | 1.570 | 0 | 777 | 94.1 |
| 27 | B3 | 82.9 | 2.466 | 1E−04 | 778 | 98.8 | 2.509 | 0 | 774 | 98.8 | 10 | 0.5 | 15 | 79.6 | 1.570 | 0 | 777 | 93.6 |
| 28 | B4 | 78.0 | 2.466 | 1E−04 | 696 | 98.5 | 2.753 | 0 | 667 | 98.8 | 20 | 0.5 | 15 | 73.7 | 1.570 | 0 | 777 | 91.5 |
| 29 | B5 | 67.3 | 2.466 | 1E−04 | 591 | 95.3 | 3.615 | 0 | 480 | 98.8 | 40 | 0.5 | 15 | 67.8 | 1.570 | 0 | 777 | 83.5 |
| 30 | B6 | 61.9 | 2.466 | 1E−04 | 556 | 92.1 | 4.285 | 0 | 399 | 98.8 | 50 | 0.5 | 15 | 67.6 | 1.570 | 0 | 777 | 78.3 |
| 31 | C1 | 82.9 | 2.466 | 1E−04 | 858 | 93.1 | 2.232 | 0 | 877 | 93.2 | 2 | 3 | 15 | 78.5 | 1.570 | 0 | 777 | 89.9 |
| 32 | C2 | 81.7 | 2.466 | 1E−04 | 824 | 93.1 | 2.266 | 0 | 841 | 93.2 | 5 | 3 | 15 | 76.8 | 1.570 | 0 | 777 | 89.8 |
| 33 | C3 | 79.7 | 2.466 | 1E−04 | 771 | 93.2 | 2.352 | 0 | 781 | 93.2 | 10 | 3 | 15 | 74.0 | 1.570 | 0 | 777 | 89.4 |
| 34 | C4 | 75.1 | 2.466 | 1E−04 | 686 | 93.1 | 2.612 | 0 | 670 | 93.2 | 20 | 3 | 15 | 69.2 | 1.570 | 0 | 777 | 87.5 |
| 35 | C5 | 65.1 | 2.466 | 1E−04 | 583 | 90.7 | 3.465 | 0 | 482 | 93.2 | 40 | 3 | 15 | 64.2 | 1.570 | 0 | 777 | 80.2 |
| 36 | C6 | 60.1 | 2.466 | 1E−04 | 550 | 87.9 | 4.114 | 0 | 401 | 93.3 | 50 | 3 | 15 | 64.1 | 1.570 | 0 | 777 | 75.4 |

_{BL}= Backer Layer
ε′_{BL} = real part of the permittivity of the backer layer
ε″_{BL} = imaginary part of the permittivity of the backer layer
d_{BL} = thickness of the backer layer

### Calculated Examples 37-54

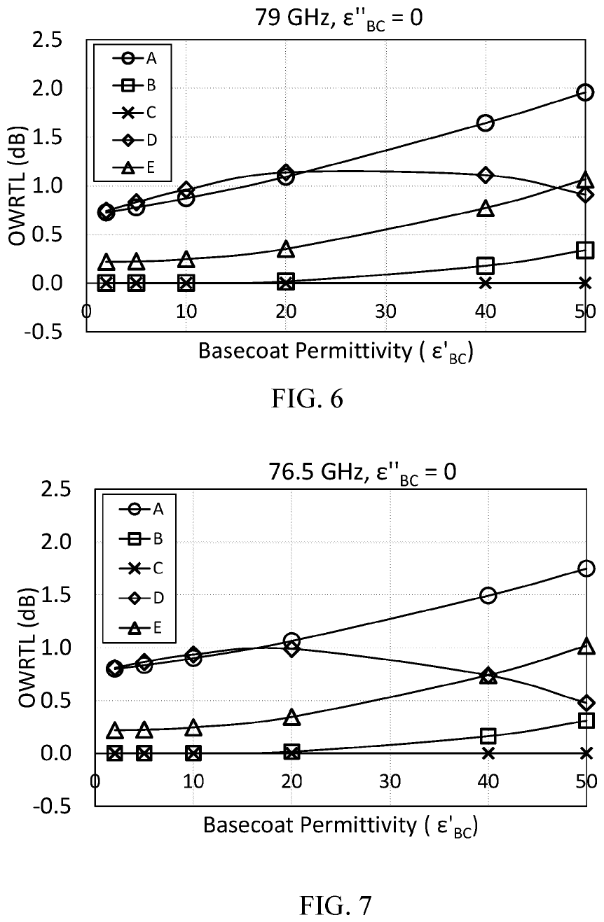

Examples 37-54 show calculated radar loss results completed in the same fashion as in Examples 1-18, except the radar frequency is 79 GHz. The results illustrated in Table 4 and plotted in FIG. 6 demonstrate the same trends as in Examples 1-36. In particular, FIG. 6 FIG. 6 is a plot of one-way radar transmission loss at 79 GHz of Examples 37-42 using methods A-E according to the Examples described herein with basecoats having an imaginary part of their permittivity values equal to 0, and for a substrate thickness of 2850 μm. As shown, method C exhibits excellent radar transmission compared to having no backer layer using Control Method A and to Comparative Method D and Comparative Method E. Method B demonstrated very good radar transmission, while Comparative Method D and Comparative Method E show mediocre to poor radar transmission, even worse than having no backer layer (Control Method A) in some cases.

TABLE 4
Examples 37-54; 79 GHz

| | | Method | | | | | | | | | | | | | | | | |
|---|---|---|---|---|---|---|---|---|---|---|---|---|---|---|---|---|---|---|
| | | | B | | | | C | | | | D | | | | E | | | |
| | | A | | | d_{BL} | | | | d_{BL} | | | | d_{BL} | | | | d_{BL} | |
| Ex. | Cond. | % T | ε′_{BL} | ε″_{BL} | (μm) | % T | ε′_{BL} | ε″_{BL} | (μm) | % T | ε′_{BL} | ε″_{BL} | (μm) | % T | ε′_{BL} | ε″_{BL} | (μm) | % T |
| 37 | A1 | 84.6 | 2.466 | 1E−04 | 765 | 100.0 | 2.465 | 0 | 765 | 100.0 | 2 | 0 | 15 | 84.3 | 1.570 | 0 | 757 | 95.1 |
| 38 | A2 | 83.6 | 2.466 | 1E−04 | 734 | 100.0 | 2.477 | 0 | 733 | 100.0 | 5 | 0 | 15 | 82.6 | 1.570 | 0 | 757 | 95.0 |
| 39 | A3 | 81.8 | 2.466 | 1E−04 | 686 | 99.9 | 2.538 | 0 | 678 | 100.0 | 10 | 0 | 15 | 80.2 | 1.570 | 0 | 757 | 94.5 |
| 40 | A4 | 77.7 | 2.466 | 1E−04 | 605 | 99.6 | 2.785 | 0 | 569 | 100.0 | 20 | 0 | 15 | 76.9 | 1.570 | 0 | 757 | 92.2 |
| 41 | A5 | 68.5 | 2.466 | 1E−04 | 502 | 96.0 | 3.855 | 0 | 370 | 100.0 | 40 | 0 | 15 | 77.4 | 1.570 | 0 | 757 | 83.7 |
| 42 | A6 | 63.7 | 2.466 | 1E−04 | 467 | 92.5 | 4.897 | 0 | 281 | 100.0 | 50 | 0 | 15 | 81.1 | 1.570 | 0 | 757 | 78.2 |
| 43 | B1 | 83.9 | 2.466 | 1E−04 | 764 | 98.7 | 2.429 | 0 | 768 | 98.7 | 2 | 0.5 | 15 | 83.0 | 1.570 | 0 | 757 | 94.1 |
| 44 | B2 | 82.9 | 2.466 | 1E−04 | 733 | 98.7 | 2.444 | 0 | 736 | 98.7 | 5 | 0.5 | 15 | 81.4 | 1.570 | 0 | 757 | 94.0 |
| 45 | B3 | 81.2 | 2.466 | 1E−04 | 684 | 98.7 | 2.506 | 0 | 680 | 98.7 | 10 | 0.5 | 15 | 79.0 | 1.570 | 0 | 757 | 93.6 |
| 46 | B4 | 77.2 | 2.466 | 1E−04 | 603 | 98.4 | 2.755 | 0 | 570 | 98.7 | 20 | 0.5 | 15 | 76.0 | 1.570 | 0 | 757 | 91.3 |
| 47 | B5 | 68.0 | 2.466 | 1E−04 | 500 | 95.0 | 3.819 | 0 | 370 | 98.7 | 40 | 0.5 | 15 | 76.4 | 1.570 | 0 | 757 | 83.0 |
| 48 | B6 | 63.3 | 2.466 | 1E−04 | 466 | 91.6 | 4.851 | 0 | 282 | 98.7 | 50 | 0.5 | 15 | 80.0 | 1.570 | 0 | 757 | 77.6 |
| 49 | C1 | 80.7 | 2.466 | 1E−04 | 764 | 92.9 | 2.266 | 0 | 781 | 93.0 | 2 | 3 | 15 | 76.7 | 1.570 | 0 | 757 | 89.8 |
| 50 | C2 | 79.8 | 2.466 | 1E−04 | 730 | 92.9 | 2.290 | 0 | 746 | 93.0 | 5 | 3 | 15 | 75.4 | 1.570 | 0 | 757 | 89.7 |
| 51 | C3 | 78.2 | 2.466 | 1E−04 | 677 | 93.0 | 2.363 | 0 | 688 | 93.0 | 10 | 3 | 15 | 73.6 | 1.570 | 0 | 757 | 89.2 |
| 52 | C4 | 74.5 | 2.466 | 1E−04 | 592 | 93.0 | 2.619 | 0 | 574 | 93.1 | 20 | 3 | 15 | 71.1 | 1.570 | 0 | 757 | 87.2 |
| 53 | C5 | 65.9 | 2.466 | 1E−04 | 492 | 90.3 | 3.654 | 0 | 373 | 93.1 | 40 | 3 | 15 | 71.5 | 1.570 | 0 | 757 | 79.6 |
| 54 | C6 | 61.5 | 2.466 | 1E−04 | 460 | 87.4 | 4.639 | 0 | 284 | 93.1 | 50 | 3 | 15 | 74.4 | 1.570 | 0 | 757 | 74.6 |

_{BL}= Backer Layer
ε′_{BL} = real part of the permittivity of the backer layer
ε″_{BL} = imaginary part of the permittivity of the backer layer
d_{BL} = thickness of the backer layer

### Calculated Examples 55-72

Examples 55-72 show calculated radar loss results completed in the same fashion as in Examples 1-18, except the substrate thickness, d_{SB}, was changed to 3000 μm for all conditions. The results illustrated in Table 5 and plotted in FIG. 7 demonstrate the same trends as in Examples 1-54.

In particular, FIG. 7 is a plot of one-way radar transmission loss at 76.5 GHz of Examples 55-72 using methods A-E according to the Examples described herein with basecoats having an imaginary part of their permittivity values equal to 0, and for a substrate thickness of 3000 μm. As shown, method C exhibits excellent radar transmission compared to having no backer layer using Control Method A and to Comparative Method D and Comparative Method E. Method B demonstrated very good radar transmission, while Comparative Method D and Comparative Method E show mediocre to poor radar transmission, even worse than having no backer layer (Control Method A) in some cases.

TABLE 5
Examples 55-72; 76.5 GHz

| | | Method | | | | | | | | | | | | | | | | |
|---|---|---|---|---|---|---|---|---|---|---|---|---|---|---|---|---|---|---|
| | | | B | | | | C | | | | D | | | | E | | | |
| | | A | | | d_{BL} | | | | d_{BL} | | | | d_{BL} | | | | d_{BL} | |
| Ex. | Cond. | % T | ε′_{BL} | ε″_{BL} | (μm) | % T | ε′_{BL} | ε″_{BL} | (μm) | % T | ε′_{BL} | ε″_{BL} | (μm) | % T | ε′_{BL} | ε″_{BL} | (μm) | % T |
| 55 | A1 | 83.2 | 2.466 | 1E−04 | 733 | 100.0 | 2.465 | 0 | 733 | 100.0 | 2 | 0 | 15 | 83.0 | 1.570 | 0 | 782 | 95.1 |
| 56 | A2 | 82.5 | 2.466 | 1E−04 | 702 | 100.0 | 2.476 | 0 | 702 | 100.0 | 5 | 0 | 15 | 81.9 | 1.570 | 0 | 782 | 95.0 |
| 57 | A3 | 81.3 | 2.466 | 1E−04 | 654 | 99.9 | 2.531 | 0 | 646 | 100.0 | 10 | 0 | 15 | 80.6 | 1.570 | 0 | 782 | 94.5 |
| 58 | A4 | 78.3 | 2.466 | 1E−04 | 572 | 99.6 | 2.772 | 0 | 533 | 100.0 | 20 | 0 | 15 | 79.6 | 1.570 | 0 | 782 | 92.4 |
| 59 | A5 | 70.9 | 2.466 | 1E−04 | 466 | 96.3 | 4.003 | 0 | 318 | 100.0 | 40 | 0 | 15 | 84.4 | 1.570 | 0 | 782 | 84.3 |
| 60 | A6 | 66.8 | 2.466 | 1E−04 | 431 | 93.1 | 5.480 | 0 | 220 | 100.0 | 50 | 0 | 15 | 89.6 | 1.570 | 0 | 782 | 79.1 |
| 61 | B1 | 82.6 | 2.466 | 1E−04 | 733 | 98.8 | 2.434 | 0 | 736 | 98.8 | 2 | 0.5 | 15 | 81.8 | 1.570 | 0 | 782 | 94.2 |
| 62 | B2 | 81.9 | 2.466 | 1E−04 | 702 | 98.8 | 2.445 | 0 | 704 | 98.8 | 5 | 0.5 | 15 | 80.8 | 1.570 | 0 | 782 | 94.1 |
| 63 | B3 | 80.7 | 2.466 | 1E−04 | 653 | 98.8 | 2.502 | 0 | 648 | 98.8 | 10 | 0.5 | 15 | 79.5 | 1.570 | 0 | 782 | 93.6 |
| 64 | B4 | 77.7 | 2.466 | 1E−04 | 570 | 98.5 | 2.743 | 0 | 535 | 98.8 | 20 | 0.5 | 15 | 78.6 | 1.570 | 0 | 782 | 91.5 |
| 65 | B5 | 70.5 | 2.466 | 1E−04 | 465 | 95.4 | 3.964 | 0 | 319 | 98.8 | 40 | 0.5 | 15 | 83.1 | 1.570 | 0 | 782 | 83.6 |
| 66 | B6 | 66.5 | 2.466 | 1E−04 | 430 | 92.2 | 5.423 | 0 | 221 | 98.8 | 50 | 0.5 | 15 | 88.1 | 1.570 | 0 | 782 | 78.5 |
| 67 | C1 | 79.7 | 2.466 | 1E−04 | 733 | 93.1 | 2.288 | 0 | 750 | 93.2 | 2 | 3 | 15 | 76.1 | 1.570 | 0 | 782 | 89.9 |
| 68 | C2 | 79.1 | 2.466 | 1E−04 | 699 | 93.1 | 2.305 | 0 | 716 | 93.2 | 5 | 3 | 15 | 75.3 | 1.570 | 0 | 782 | 89.9 |
| 69 | C3 | 77.9 | 2.466 | 1E−04 | 645 | 93.2 | 2.367 | 0 | 658 | 93.3 | 10 | 3 | 15 | 74.2 | 1.570 | 0 | 782 | 89.4 |
| 70 | C4 | 75.2 | 2.466 | 1E−04 | 560 | 93.2 | 2.609 | 0 | 540 | 93.3 | 20 | 3 | 15 | 73.5 | 1.570 | 0 | 782 | 87.5 |
| 71 | C5 | 68.4 | 2.466 | 1E−04 | 456 | 90.7 | 3.783 | 0 | 322 | 93.3 | 40 | 3 | 15 | 77.1 | 1.570 | 0 | 782 | 80.3 |
| 72 | C6 | 64.6 | 2.466 | 1E−04 | 423 | 88.0 | 5.159 | 0 | 224 | 93.3 | 50 | 3 | 15 | 80.9 | 1.570 | 0 | 782 | 75.5 |

_{BL}= Backer Layer
ε′_{BL} = real part of the permittivity of the backer layer
ε″_{BL} = imaginary part of the permittivity of the backer layer
d_{BL} = thickness of the backer layer

### Experimental Examples 73-92

Experimental coating layers were generated to demonstrate the effect of fillers on the real and imaginary permittivity of a coating as measured at a frequency range of 65-85 GHz. Incorporation of fillers into an example second layer 106, or backer layer, was demonstrated by dispersing fillers into a two-component epoxy-amine formulation and application of the formulation to TPO panels. The epoxy resin matrix comprised 63.6 wt % EPON 863 (commercially available from HEXION) and 36.4 wt % ANCAMINE 2638 (commercially available from EVONIK). Filler was dispersed into the epoxy and/or amine side, at the desired pigment volume concentration (PVC), by mixing for 2 min at 2350 rpm in a FLACKTECK SPEEDMIXER. The epoxy and amine were mixed for 2 min at 2350 rpm, then the compositions were immediately applied to TPO panels (LYONDELL-BASELL HIFAX TRC779X, 4 inches×6 inches×nominal 0.118 inch, available from STANDARD PLAQUE INC.) via a drawdown bar with a 20 mil gap. The compositions were allowed to cure for 24 h then thickness was measured using calipers. The permittivity of the backer layers was measured using a suitable permittivity measurement device/system employing the frequency range of 65 GHz to 85 GHz.

| | | % PVC | | |
|---|---|---|---|---|
| Example | Filler | Filler | ε′ | ε″ |
| 73 | None | 0 | 2.68 | 0.17 |
| 74 | TIONA 595¹ | 12.1 | 4.30 | 0.32 |
| 75 | TIONA 595 | 21.7 | 6.46 | 0.49 |
| 76 | TIONA 595 | 29.3 | 6.95 | 0.64 |
| 77 | TIONA 595 | 35.6 | 8.80 | 0.63 |
| 78 | Barium Titanate² | 15.9 | 4.64 | 0.48 |
| 79 | Barium Titanate | 22.1 | 6.83 | 0.71 |
| 80 | Calcium Copper Titanate³ | 19.4 | 5.92 | 0.39 |
| 81 | Calcium Copper Titanate | 26.6 | 6.54 | 0.57 |
| 82 | Calcium Copper Titanate | 32.5 | 8.78 | 0.64 |
| 83 | MAPICO BLACK 845⁴ | 10.3 | 5.61 | 0.74 |
| 84 | MAPICO BLACK 845 | 18.6 | 9.30 | 1.41 |
| 85 | MAPICO BLACK 845 | 25.6 | 12.16 | 1.98 |
| 86 | SULFEX RED⁵ | 19.4 | 4.89 | 0.62 |
| 87 | SULFEX RED | 26.6 | 6.97 | 1.07 |
| 88 | SULFEX RED | 32.5 | 9.15 | 1.34 |
| 89 | MARTOXID TM-3310⁶ | 22.2 | 3.16 | 0.20 |
| 90 | MARTOXID TM-3310 | 29.9 | 3.28 | 0.17 |
| 91 | CR-41⁷ | 16.8 | 3.19 | 0.23 |
| 92 | CR-41 | 23.3 | 3.60 | 0.27 |

¹Titanium dioxide, commercially available from TRONOX LTD.
²Commercially available from ACROS ORGANICS
³Commercially available from XI'AN FUNCTION MATERIAL GROUP CO.
⁴Iron oxide, commercially available from VENATOR MATERIALS PLC
⁵Iron sulfide, commercially available from WASHINGTON MILLS
⁶Aluminum oxide, commercially available from J.M. HUBER CORP
⁷Zinc oxide, commercially available from WESTERN RESERVE CHEMICALS

The examples demonstrate that the incorporation of specific fillers into a film forming resin increases the real permittivity (ε′) of the layer. In certain cases, metal oxides such as titanium dioxide increase the real permittivity (ε′) while maintaining lower imaginary permittivity (ε″) values. In certain cases, a second layer 106 with high real permittivity is required to sufficiently increase the radar transmission of the radar transmissive system.

### Experimental Examples and Some Comparative Calculated Examples 93-99

To experimentally demonstrate the improved radar transmission enabled by application of a second layer 106, pigmented multilayer films were applied as second layer 106. The multilayer films consisted of a pressure sensitive adhesive layer, a pigmented thermoplastic polyurethane layer, a clear thermoplastic polyurethane layer, and a thermoset polyurethane clearcoat. A storm gray and metallic red film were used. The multilayer films were applied in one or multiple layers to the second surface, 102b, of a thermoplastic polyolefin (TPO) panel (LYONDELL-BASELL HIFAX TRC779X, 4 inches×6 inches×nominal 0.118 inch, from STANDARD PLAQUE, INC.), the other side of which was coated with a coating stack. The permittivity of each film type was measured by applying each film to an uncoated TPO panel and then by using a permittivity measurement system, knowing previously the permittivity of the TPO panel, and measuring the thicknesses with a caliper. All of the measured permittivity values are summarized in Table 6.

### Example 93—TPO Panel with Conventional Coating Stack

An uncoated TPO panel was scrubbed with a CLEAN AND SCUFF SPONGE (SU4901, from PPG INDUSTRIES, INC.), after which the panel was blown dry. Then the panel was wiped with an adhesion wipe (SU4902, from PPG INDUSTRIES, INC.). After about 5 minutes, when the panel was dry, it was sprayed with ADVANCED PLASTIC BOND aerosol (SUA4903, from PPG INDUSTRIES, INC.). After about 5 to 10 minutes, when this was dry, a sealer (4:1:1 by volume mixture of ECS25, EH391, and DT1855, from PPG INDUSTRIES, INC.) was applied with a spray gun (SATA jet BF 100 with 1.4 mm nozzle). After this a basecoat (83.33% by weight T474 and 16.67% by weight T494 from PPG INDUSTRIES, INC.) was applied by spray gun (SATA JET 4000 HVLP with WSB nozzle). Finally, a clear coat (4:1 by volume of DC4000 and DCH3085, from PPG INDUSTRIES, INC.) was applied by spray gun (IWATA WS400 with 1.3 mm nozzle). After clear coat application, the coated panels were baked at 60° C. for 30 min or allowed at least 12 h at ambient conditions prior to further handling. Then the panels remained at ambient conditions for at least seven days after coating application. The one-way radar transmission loss at 76.5 GHz of the coated panel was measured using an R&S device and is shown in Table 7. This thickness of each coating layer was measured by spraying the coating also onto a metal panel at the same time it was applied to the TPO panel, and using a suitable film/coating thickness measurement device, as outlined herein, to determine the cured film thickness.

The permittivity of the uncoated TPO panel was measured using a suitable permittivity measurement system as outlined herein. The permittivity of each coating layer (sealer, basecoat, and clearcoat) was measured by applying each layer individually to individual TPO panels and then by using a permittivity measurement system, knowing previously the permittivity of the TPO panel.

### Examples 94-99—Demonstrate Application of Backer Layers to the Coated TPO Panel from Example 93

### Example 94

One layer of the metallic red multilayer film (222.5 μm thick) was applied to the second surface, 102b, of Example 93 such that entrapped air between the film and the panel was minimized. The one-way radar transmission loss at 76.5 GHz of this combined radar transmission system (backer layer+TPO panel+coatings stack) was measured using an R&S device and is shown in Table 7. The one-way radar transmission loss at 76.5 GHz was also predicted by transfer matrix method calculation using the thickness and permittivity data in Table 6 and is shown in Table 7.

### Example 95

A second layer of metallic red multilayer film was applied over the already applied film (for a total thickness of 445.0 μm of film) with minimal entrapped air, on Example 94. The one-way radar transmission loss at 76.5 GHz of this combined radar transmission system (2 backer layers+TPO panel+coatings stack) was measured using an R&S device and is shown in Table 7. The one-way radar transmission loss at 76.5 GHz was also predicted by transfer matrix method calculation using the thickness and permittivity data in Table 6 and is shown in Table 7.

### Calculated Example 96

Using the permittivity and thickness of the TPO panel and each of the coating layers of Example 93 (see Table 6), a thickness was calculated for a theoretical optimized backer layer having the same permittivity as the metallic red multilayer film, that minimized the one-way radar transmission loss at 76.5 GHz for Example 93 with this theoretical backer layer applied to the back (uncoated side) of Example 93. The thickness of this theoretical backer layer and the resulting calculated, minimized one-way radar transmission loss at 76.5 GHz is shown in Table 7.

### Example 97

All the metallic red multilayer films were removed from Example 95, to expose again the second surface, 102b, of the original Example 93. The one-way radar transmission loss at 76.5 GHz of this coated panel was again measured and confirmed to be exactly the same as the original Example 93. Then one layer of the storm gray multilayer film (130.5 μm thick) was applied to the back (uncoated side) of Example 93 such that there was minimal entrapped air between the film and the panel. The one-way radar transmission loss at 76.5 GHz of this combined radar transmission system (backer layer+TPO panel+coatings stack) was measured using an R&S device and is shown in Table 7. The one-way radar transmission loss at 76.5 GHz was also predicted by transfer matrix method calculation using the thickness and permittivity data in Table 6 and is shown in Table 7.

### Example 98

Three more layers of storm gray multilayer film were applied over the already applied film (for a total thickness of 522.0 μm of film) with minimal entrapped air, on Example 97. The one-way radar transmission loss at 76.5 GHz of this combined radar transmission system (4 backer layers+TPO panel+coatings stack) was measured using an R&S device and is shown in Table 7. The one-way radar transmission loss at 76.5 GHz was also predicted by transfer matrix method calculation using the thickness and permittivity data in Table 6 and is shown in Table 7.

### Calculated Example 99

Using the permittivity and thickness of the TPO panel and each of the coating layers of Example 93 (see Table 6), a thickness was calculated for a theoretical optimized backer layer having the same permittivity as the storm gray multilayer film, that minimizes the one-way radar transmission loss at 76.5 GHZ for Example 93 with this theoretical backer layer applied to the back (uncoated side) of Example 93. The thickness of this theoretical backer layer and the resulting calculated, minimized one-way radar transmission loss at 76.5 GHz is shown in Table 7. The one-way radar transmission loss at 76.5 GHz was also predicted by transfer matrix method calculation using the thickness and permittivity data in Table 6 and is shown in Table 7.

TABLE 6
Measured permittivity values (real part ε′, and imaginary
part ε″) and thickness (d) for the TPO panel,
coating layers, and pigmented multilayer films.

| Material | d (μm) | ε′ | ε″ | tan δ |
|---|---|---|---|---|
| TPO panel | 2775 | 2.466 | 0.0001 | 0.000 |
| Sealer layer (solid) | 12.2 | 5.000 | 0.010 | 0.002 |
| Basecoat layer (solid) | 17.3 | 59.079 | 4.076 | 0.069 |
| Clearcoat layer (solid) | 50.5 | 2.890 | 0.023 | 0.008 |
| Metallic Red Multilayer | 222.5 | 5.345 | 0.225 | 0.042 |
| film | | | | |
| Storm Gray Multilayer | 130.5 | 3.216 | 0.193 | 0.060 |
| film | | | | |

TABLE 7
Measured and predicted values of one-way radar transmission loss
in dB at 76.5 GHz and backer layer thickness values.

| | | Number | Total | Measured | |
|---|---|---|---|---|---|
| | | of Applied | Backer | one-way | Predicted one- |
| | Backer | Backer | Layer | radar | way radar |
| | Layer | Layer | Thickness | transmission | transmission |
| Example | ε′ | Films | (μm) | loss (dB) | loss (dB) |
| 93 | — | 0 | 0 | 3.36 | 3.35 |
| 94 | 5.345 | 1 | 222.5 | 2.15 | 1.97 |
| 95 | 5.345 | 2 | 445.0 | 0.85 | 0.96 |
| 96 | 5.345 | — | 395.9 | — | 0.84 |
| 97 | 3.216 | 1 | 130.5 | 2.91 | 3.06 |
| 98 | 3.216 | 4 | 522.0 | 1.14 | 1.31 |
| 99 | 3.216 | — | 506.7 | — | 1.30 |

Table 7 demonstrates theoretically that a backer layer thickness can be predicted from transfer matrix method calculation using the thickness and permittivity of the substrate and all the coatings layers of a radar transmission system, such that when this backer layer is applied at this thickness onto coated substrate (radar transmission system) with a high value of one-way radar transmission loss (such as Example 93), the one-way radar transmission loss can be significantly reduced (such as Examples 95 and 98). Example 95 which has a thickness close to that of Example 96, and Example 98 which has a thickness close to Example 99 demonstrate experimentally, that when an applied backer layer thickness is close to (within about 100 microns) of the theoretical optimum thickness, the one-way radar transmission loss can be significantly reduced. Table 7 also demonstrates that applied backer layers of higher permittivity can enable a more significant decrease in one-way radar transmission loss. Compare the lower one-way radar transmission loss values of Examples 95 and 96 to the somewhat higher values of one-way radar transmission loss for Examples 98 and 99, where the backer layers of Examples 95 and 96 have a higher permittivity than those of Examples 98 and 99.

Notwithstanding that the numerical ranges and parameters setting forth the broad scope of the disclosure are approximations, numerical values set forth in the specific examples are reported as precisely as possible. Any numerical value, however, inherently contains certain errors necessarily resulting from the standard variation found in their respective testing measurements.

Whereas particular examples have been described above for purposes of illustration, it will be evident to those skilled in the art that numerous variations of the details of the present disclosure may be made without departing from the disclosure as defined in the appended claims.

The term “average” as used herein means a “mean” of any variable, x, such as wavelength, diameter, lateral size, thickness, and so forth, is calculated by the equation: average=(1/N)Σxᵢ, where N values of the variable x are being averaged, such that i=1 to N, and Σxᵢ=x₁+x₂+ . . . +x_{N}, as understood by one of ordinary skill in the art.

Various features and characteristics are described in this specification to provide an understanding of the composition, structure, production, function, and/or operation of the present disclosure, which includes the disclosed compositions, coatings, and methods. It is understood that the various features and characteristics of the present disclosure described in this specification can be combined in any suitable manner, regardless of whether such features and characteristics are expressly described in combination in this specification. The Inventors and the Applicant expressly intend such combinations of features and characteristics to be included within the scope of the present disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

Any patent, publication, or other document identified in this specification is incorporated by reference into this specification in its entirety unless otherwise indicated but only to the extent that the incorporated material does not conflict with existing descriptions, definitions, statements, illustrations, or other disclosure material expressly set forth in this specification. As such, and to the extent necessary, the express disclosure as set forth in this specification supersedes any conflicting material incorporated by reference. Any material, or portion thereof, that is incorporated by reference into this specification but that conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference. The 5 amendment of this specification to add such incorporated subject matter will comply with the written description, sufficiency of description, and added matter requirements.

While the present disclosure provides descriptions of various specific aspects for the purpose of illustrating various aspects of the present disclosure and/or its potential applications, it is understood that variations and modifications will occur to those skilled in the art. Accordingly, the present disclosure herein should be understood to be at least as broad as claimed and not as more narrowly defined by particular illustrative aspects provided herein.

1. A radar transmissive system comprising:
a substrate layer comprising a first surface and a second surface positioned opposite the first surface, wherein the second surface is configured to be directed towards a radar system;
a first layer applied over at least a portion of the first surface of the substrate layer; and
a second layer applied over at least a portion of the second surface of the substrate layer, wherein a dry film thickness of the second layer is configured to reduce radar transmission loss through the radar transmissive system based on a permittivity and a thickness of the substrate layer and the first layer;
wherein the radar transmissive system transmits 50% or greater of electromagnetic radiation through the radar transmissive system within a frequency range of from 1 GHz to 300 GHz.

2. The radar transmissive system of claim 1, wherein the radar transmissive system transmits 50% or greater of electromagnetic radiation through the radar transmissive system within a frequency range of from 76 GHz to 81 GHz.

3. The radar transmissive system of claim 1, wherein the radar transmissive system transmits 70% or greater of electromagnetic radiation through the radar transmissive system within a frequency range of from 76 GHz to 81 GHz,

4. The radar transmissive system of claim 1, wherein:
the substrate layer has a first real permittivity as measured at a frequency in a range of 76 GHz to 81 GHz;
the second layer has a second real permittivity as measured at a frequency in a range of 76 GHz to 81 GHz; and
a difference between the first real permittivity and the second real permittivity is no greater than 0.5.

5. The radar transmissive system of claim 1, wherein:
the substrate layer has a first real permittivity as measured at a frequency in a range of 76 GHz to 81 GHz;
the second layer has a second real permittivity as measured at a frequency in a range of 76 GHz to 81 GHz; and
a difference between the first real permittivity and the second real permittivity is 0.5 or greater.

6. (canceled)

7. The radar transmissive system of claim 4, wherein the first real permittivity is less than the second real permittivity.

8. (canceled)

9. (canceled)

10. The radar transmissive system of claim 4, wherein the first real permittivity is in a range of 1.5 to 4.

11. (canceled)

12. The radar transmissive system of claim 4, wherein:
the first layer has a real permittivity in a range of from 5 to 70 as measured at a frequency in a range from 76 GHz to 81 GHz.

13. The radar transmissive system of claim 1, wherein:
the second layer has an imaginary part of permittivity as measured at a frequency in a range of 76 GHz to 81 GHz that is less than 2.0.

14. (canceled)

15. (canceled)

16. The radar transmissive system of claim 1, wherein the second layer is a coating and is in direct contact with the substrate layer.

17. The radar transmissive system of claim 1, wherein the second layer has a uniform thickness where a thickness across the second layer does not vary more than 20%, or more than 10% of the average thickness of the second layer.

18. The radar transmissive system of claim 1, wherein the second layer comprises a filler, wherein the filler is contained in the layer at a volume concentration of 0.1% to 90%.

19. The radar transmissive system any of claim 1, wherein the filler comprises a metal oxide, a metal titanate, or a combination thereof.

20. The radar transmissive system of claim 1, wherein the second layer comprises polyetheretherketone, polyphenylene sulfide, polyetherimide, polyurethane, a polyolefin or a fluoropolymer, or combinations thereof.

21. (canceled)

22. The radar transmissive system of claim 1, wherein the second layer comprises a multilayer film comprising an adhesive layer.

23. (canceled)

24. The radar transmissive system of claim 1, wherein the first layer comprises a film-forming resin and a pigment.

25. (canceled)

26. (canceled)

27. The radar transmissive system of claim 1, wherein the second layer comprises a dry film thickness in a range of 100 μm to 1000 μm.

28. The radar transmissive system of claim 1, further comprising a pretreatment layer, an adhesion promoter layer, a basecoat layer, a mid-coat layer, a topcoat layer, a primer layer, or a combination thereof applied over at least a portion of the first surface.

29. The radar transmissive system of any of claim 1, wherein the dry film thickness and a permittivity of the second layer is configured to reduce radar transmission loss through the radar transmissive system based on a permittivity and a thickness of each layer in the radar transmissive system.

30. (canceled)

31. The radar transmissive system of any of claim 1, wherein the substrate layer is a bumper fascia or a fender.

32. (canceled)

33. (canceled)

34. (canceled)
